(19) United States
(12) Patent Application Publication
(10) Pub. No.: US 2003/0076369 A1
(43) Pub. Date: Apr. 24, 2003

(54) System and method for presentation of remote information in ambient form

(76) Inventors: Benjamin I. Resner, Roxbury, MA (US); David L. Rose, Cambridge, MA (US); Pritesh V. Gandhi, Allston, MA (US); Nabeel Hyatt, Boston, MA (US); Christopher McRobbie, Brookline, MA (US)

Correspondence Address: MILLS & ONELLO, LLP, Suite 605, Eleven Beacon Street, Boston, MA, 02108, US

(21) Appl. No.: 10/247,780

(22) Filed: Sep. 19, 2002

Related U.S. Application Data
(60) Provisional application No. 60/323,493, filed on Sep. 19, 2001.
(60) Provisional application No. 60/358,272, filed on Feb. 20, 2002.
(60) Provisional application No. 60/398,648, filed on Jul. 25, 2002.

(51) Int. Cl. G09G 5/00; G06F 15/16

(52) U.S. Cl. 345/864; 709/217

(57) ABSTRACT

In a system and method for the display, or presentation, of electronic information in an ambient, or pre-attentive, form, a centralized server converts textual or quantitative data into a form suitable for remotely located non-textual ambient displays, or objects. The conversion, or translation, of the information occurs in response to a set of rules which may be fixed at the server, or otherwise modifiable by a user of the display, for example via Web-based interface, or at the display itself. The translated data, referred to herein as “ambient data” is in compressed, encoded form, so as to optimize the efficiency of its periodic transmission of such data to multiple remotely located recipient displays. In one example, the display comprises an analog-type gauge having a hand that varies in angular or linear offset, or multiple hands that independently vary in angular or linear offset, in response to the received ambient data. In another example, the transmission of data from the information server to the ambient displays occurs via a one-way or two-way wireless network.

### RELATED APPLICATIONS

This application claims the benefit of U.S. Provisional Application No. 60/323,493, filed Sep. 19, 2001, U.S. Provisional Application No. 60/358,272, filed Feb. 20, 2002, and U.S. Provisional Application No. 60/398,648, filed Jul. 25, 2002.

### BACKGROUND OF THE INVENTION

Clocks have been in existence for hundreds of years. When reliable clocks were first designed, they were large and expensive—so large and expensive, in fact, it took the combined resources of an entire city to build a single clock. Such a clock was typically installed on top of a tower visible to the entire population. Knowledge of time required living within visual range of the clock. Even the wealthiest individuals did not have the resources to own a device capable of displaying accurate time.

As technology improved, clocks became smaller and more affordable. Wealthy families could afford to install one in their own home. They occupied considerable space, had extensive setup procedures, and required daily maintenance. Nevertheless, they represented a large improvement in convenience over the tower-mounted models that preceded them. This trend of miniaturization and ease of operation continued until clocks eventually became small enough that they could be carried by an individual, and even worn on a wrist.

Today, clocks are ubiquitous and run unsupervised for years on an inexpensive battery. Most homes have dozens of clocks—many of them not even being the intended purchase. For example, coffee machines, VCRs, microwave ovens, pocket calculators, stereo consoles, and personal music players all include clocks, yet a consumer rarely purchases that particular product for the clock itself. Clocks have become so inexpensive, small, reliable and easy to operate that customers are commonly unaware that they are included in the purchase.

Despite this innovation, contemporary clocks are somewhat limited in the information they convey. Most clocks provide information on the time of day for a specific location. Some clocks also feature time derivatives such as moon phase, tides, calendar, or even eclipses. A clock can be set to a time zone other than the one in which is situated (such as if found in a newsroom or hotel lobby), but it cannot display information such as weather or traffic congestion. Clocks provide minimal functionality beyond the ability to tell time. While deployment of clocks has become very widespread, the information conveyed has not significantly increased. Certain improvements, such as the addition, first of a minute hand, and later, of a second hand, improved the utility of clocks, but clocks still only displayed time. Designers have explored many different presentations of time, and have included functionality such as calculators or compasses, but all clocks are essentially restricted to conveying time and other locally acquired and configured information.

Another trend has been the increased standardization of digitally formatted online information. The best example of this is the World Wide Web. Users can employ a variety of web browser tools working on many different operating systems to go online and extract a variety of information from remote servers. This information may include personal/social information such as email messages or factual information such as stock price, weather forecast, or snow conditions. The key feature of much of this online information is the ease with which it can be publicly accessed through a wide range of computer terminals or similar electronic devices. In particular, the World Wide Web enables this mass of information to be accessed using equipment costing less than $1000 by non-computer professionals. The availability of data in the standardized HTML format has enabled web browsers to link to a vast array of data.

Such standardization has also made it convenient for individuals to publish information in a format that is accessible to the entire network. This is in contrast with conventional information transmission standards such as television or radio, which require expensive government licenses to prevent overcrowding of limited electromagnetic bandwidth, as well as considerable expense and expertise in installing broadcasting towers.

An ever-increasing number of companies are making a wide variety of information, including private and public information, available online. For instance, several companies focus on collecting biometric readings such as blood pressure or glucose levels of individuals. Connected devices, such as web-based computers and wireless devices, are employed to transmit this information to a web server. Users with proper access privileges are then able to view this collected information using a standard web browser. In addition, certain companies specialize in “account aggregation” which refers to capturing data from several different sources, and aggregating them into a unified format for convenient display on a web browser.

As standardized networks such as the Internet grew over the past decade, the traditional means of interacting with this information was through desktop computers physically wired to the network. Even though desktop and laptop computers have significantly lowered in price, size, and complexity, several factors continue to prevent their ubiquity. Traditional computers require two hands to operate, and generally require a flat surface. Battery powered laptops eliminate the need for a power source (for a few hours, at most), but they still need to be connected to a network in order to access information.

The deployment of wireless networks has freed information from being tethered to a network. Pagers, cell phones, and a growing assortment of “personal data assistants” (PDA) such a Palm Pilots™ offer wireless connectivity and web content without the requirement of being physically attached to a network, without having to interact with a computer screen, and without requiring both hands.

Convergence of wireless standards and aggressive deployment have increased the geographical range where various wireless devices can receive a signal. No longer limited to a few major metropolitan areas, wireless networks now cover over 99% of the United States population. The most popular of these networks include GSM, FLEX, reFLEX, and Cellular Digital Packet Data (CDPD).

When a user acquires information online, this operation is referred to as “pull” because the user actively seeks, or pulls, the information from the World Wide Web network, onto the computer and into his or her conscious awareness, for example by visiting a Web page. If the user does not seek out the information, he or she remains ignorant. With a “pull” operation, there is no way for the information to announce itself.

In a “push” operation, on the other hand, information is alerted to the user automatically when certain conditions have been met. For instance, most pager and cell phone companies, as well as third-party technology providers such as MicrosoftlM .NET alerts, allow users to configure information to be sent to them at specified temporal intervals, or when certain preset conditions have been met. For instance a user can have the weather forecast sent to them every day at 1:00 PM, or alerted if the price of a stock goes above or below a predetermined percentage.

Pull data is more useful if in-depth knowledge of a topic is required. The user is allowed to carefully select which aspects of the information are most relevant, and can “drill down” into those details he or she finds most significant. Push data, on the other hand, tends to be more superficial. Push alerts often lead to a user eventually drilling-down via pull operations to obtain more detailed knowledge about the events that triggered the push, or the information that was contained in the push. Information push and pull work hand-in-hand, since without the information push, the user may not have initiated the information pull session.

While portable-battery-operated wireless devices offer a distinct improvement over wired desktop computers for certain types of information awareness, they are still interruptive and often socially inappropriate. Push information announces itself with a beep or vibration that demands prompt intervention. In response, the user must then interrupt whatever he or she was doing to visually or aurally process the message. Current technologies present such push information as either printed text (such as on an LCD screen) or through spoken language (such as a computer or human-generated voice, either live or recorded). While the user is processing this information, however brief this interval, he or she is precluded from attending to other tasks such as conversing with others or driving a car. Pagers, cell phones, and wired PDAs still require the user to interrupt what he or she is doing to acquire the push information contained. If the message is ignored, it is often forgotten about, and not read until the passage of time has rendered it irrelevant.

Because push alerts can arrive at any time and without any warning, these interruptions are often inconvenient and socially awkward. While they contain valuable and relevant information, users are often not situated to take action on the information. Users can ask to be reminded at a specified interval, but the reminder often suffers the same fate as the initial alarm. Users can quickly habituate to the barrage of push alerts coming into their devices.

This problem afflicts more than just portable devices. Computer screens are becoming increasingly cluttered with various tickers, animations, and alerts indicating presence of new email, stock prices, weather forecast, or upcoming time-sensitive appointments. These animations compete for the valuable space on)computer desktops.

A much researched solution to this dilemma between irritating interruptions and informational ignorance has been the development of “intelligent systems” which use various algorithms to make intelligent decisions about when to push information to the user. These systems observe usage and interaction patterns to form decision networks about when a user should be interrupted, and how the interruption should be presented. In this way, these intelligent systems are similar to the manner in which a human assistant filters information for his or her supervisor. The human assistant utilizes various signals including tone of voice, facial expression, task schedule, day of week, weather conditions, and news headlines to make a decision regarding whether the individual should be interrupted. The most sophisticated of these automated systems use sensors and other technologies to acquire and process as much of this information as possible in order to make the same informed decision as a human.

While this approach is promising, our lack of understanding of how humans make decisions, coupled with the difficulty of acquiring physiological data such as facial expression or eye gaze has severely limited the usefulness of these systems. Intelligent agents have found niche success for applications such as email filtering, but such systems have not found widespread use. Despite huge technical obstacles and limited real-world success, the persistent research into intelligent agents demonstrates the demand of users for improved methods of filtering the presentation of digital information.

Another simplification which has led to greater usability of portable devices is the use of remote configuration of devices through computer software and web interfaces. Because entering or configuring data on a small portable device without a keyboard and full-sized screen is difficult, clever designers have connected these devices to computers where they can take advantage of a computer's full-sized keyboard and easy-to-read color display. By making configuration easier, devices can be configured more precisely, and therefore have a increased chance of presenting information in a time and manner that is useful and not interruptive.

PDA devices commonly use a technique referred to as “graffiti™” to allow a user to enter text directly on the device. While this is a vast improvement over other text input techniques (ultra-small keyboards, 2-button push-select interfaces), this interface is still operationally slow when compared to entering text on a computer using a keyboard and screen. The usability of PDA devices is in large part due to their ability to connect to a computer and to be configured through that connection.

The above-described trends in wireless information communication have enabled this form of remote configuration to be distributed over the Web where the device and computer have no direct-wired or wireless proximate connection. Cell phone phonebook directories can now be programmed through standard web interfaces. The user enters information a web browser, and the browser then transmits that information to the remote cell phone. This is generally much simpler than entering new phone numbers directly on the phone. Similarly, push information sent to a pager is configured through an online web interface, rather than through the two or three buttons and 20-character display found on a typical pager. While pagers and other portable devices are much easier to transport and ideal for reading a few lines of textual message, they are not suited to any task requiring the input of textural information, such as that required for most any configuration.

While web configuration is an excellent general-purpose solution, and is often much more powerful than a local interface, it still requires users to actively engage the online environment, a task that many individuals are still reluctant to do.

### SUMMARY OF THE INVENTION

The present invention is directed to a system and method for the display, or presentation, of electronic information in an ambient, or pre-attentive, form. In contrast to the interruptive and event-driven pagers and cell phones described above, ambient information is always on and provides a constant awareness of information trends. The present invention is concerned more specifically with the configuration and compression of ambient data by a centralized “ambient information server” to make it economical and easy to configure and distribute a wide range of ambient data to a wide range of remote ambient devices in a commercial setting.

This centralized ambient information server converts textual or quantitative data into a form suitable for remotely located non-textual ambient displays, or objects. The conversion, or translation, of the information occurs in response to a set of rules which may be fixed at the server, or otherwise modifiable by a user of the display, for example via Web-based interface, or at the display itself. The translated data, referred to herein as “ambient data” is in compressed, encoded form, so as to optimize the efficiency of its periodic transmission to the remote displays. In one example, the display comprises an analog-type gauge having a hand that varies in angular or linear offset, or multiple hands that independently vary in angular or linear offset, in response to the received ambient data. In another example, the transmission of data from the information server to the ambient displays occurs via a one-way or two-way wireless network.

In one aspect, the present invention is directed to a system and method for the ambient presentation of information from a remote source. An information server receives information from an information source. A translation unit translates the information to an ambient data element, the ambient data element being optimized for presentation at a remote ambient object in ambient form. The translation unit optionally comprises software operating at the information server that translates the information to the ambient data element in response to translation rules. The translation rules may be programmable by a user of the ambient object, for example via a web-based interface, or via an electronic interface such as telephonic, wireless, and pager devices. Alternatively, the translation rules are programmable at the ambient object itself. In addition, the translation rules may be fixed at the information server.

A transmission system communicates the ambient data element to the remote ambient object. The transmission system may comprise, for example, a one-way wireless communication system, a two-way wireless communication system, or a wired system. The transmission system may optionally comprise a distributed data network, such as a commercial pager, telephone, wireless data, and public Internet-based networks.

An aggregation unit may be included for aggregating multiple ambient data elements into an ambient data packet, in which case the transmission system communicates the ambient data packet to multiple remote ambient objects. In the case where the transmission system comprises a wireless transmission system, the ambient data packet is configured for transfer by the wireless transmission system. The ambient objects are thus programmed to receive an ambient data packet and to extract the respective ambient data element designated for the ambient device from the ambient data packet.

In one example, the aggregation unit aggregates the multiple ambient data elements adjacent each other in the ambient data packet and the ambient device extracts the ambient data element from the ambient data packet according to a programmed numeric offset that corresponds to the position of the ambient data element in the ambient data packet. The numeric offset may be fixed or variable.

Alternatively, the aggregation unit aggregates the multiple ambient data elements into the ambient data packet with an associated element identification header, and the ambient device extracts the ambient data element from the ambient data packet in response to the element identification header.

Alternatively, the aggregation unit aggregates the multiple ambient data elements into the ambient data packet and the ambient object extracts the ambient data element from the ambient data packet in response to a programmable selection signal.

The programmable selection signal may be generated at the ambient object, or generated in response to a medium that interfaces with the ambient object. The medium may comprise, for example, a swappable gauge face, a printed medium, an electronic medium, or a magnetic medium. Alternatively, the programmable selection signal is generated in response to a dial or switches located at the ambient object.

The ambient data is preferably optimized for instructing the ambient object for presentation of the information in ambient form, so as to minimize the amount of data that is transferred from the information server to the ambient object.

The ambient object may comprise an object such as a light-emitting device of varying wavelength emission, a gauge with hands of varying angular or linear offset; and a device that varies in mass or force required to operate. The ambient object may comprises an object that is wearable on a human body, such as a wristwatch-type device having a gauge with at least one hand that varies in angular or linear offset in response to the ambient data.

The information that is translated to ambient form comprises, for example, textural or quantitative electronic data related to an event that is remote from the ambient object.

In another aspect, the present invention is directed to an ambient object for the ambient presentation of remote information. The object includes a receiver for receiving an ambient data element from a remote information source, the ambient data element being optimized for presentation at the ambient object, and being representative of remote information

The remote information source may comprise an information server. The receiver may comprise a wireless data packet receiver.

The ambient data element is optionally received in aggregated form with multiple ambient data elements in an ambient data packet, in which case the receiver extracts the respective data element designated for the ambient device from the ambient data packet. The receiver may extract the ambient data element from the ambient data packet according to a programmed numeric offset that corresponds to the position of the ambient data element in the ambient data packet. The numeric offset may be fixed or variable. Alternatively, the receiver extracts the ambient data element from the ambient data packet in response to an element identification header, or in response to a programmable selection signal.

The programmable selection signal may be generated at the ambient object, or in response to a dial or switches located at the ambient object. Optionally, the programmable selection signal is generated in response to a medium that interfaces with the ambient object, such as a swappable gauge face, a printed medium, an electronic medium, and a magnetic medium.

In one example, the presentation unit comprises a light source, the emitted wavelength (color) of which is varied in response to the received ambient data element. In another example, the presentation unit comprises a gauge having a hand and a controller for varying the angular or linear offset of the hand with respect to the gauge in response to the received ambient data element. The gauge may be wearable on a human body, for example in the form of a wristwatch-type device.

In one embodiment, the hand may comprise multiple hands and the controller varies the angular or linear offset of each of the multiple hands independently, in response to multiple aspects of the remote information.

The remote information may comprise textural or quantitative electronic data related to an event that is remote from the ambient object. The ambient data element is translated from the remote information at an information server that is remote from the ambient object, for example, in response to translation rules. The translation rules are programmable by a user of the ambient object via a web-based interface or are programmable at the ambient object itself, or are fixed at the information server.

In another aspect, the present invention is directed to an ambient object for the ambient presentation of remote information. The object comprises a gauge with a hand and a receiver for receiving information from a remote information source. A controller varies the angular or linear offset of the hand with respect to the gauge in response to the received information.

The gauge is preferably wearable on a human body, for example in the form of a wristwatch-type device.

The information received from the remote information source may comprise ambient data that is optimized for instructing the controller for varying the angular or linear offset of the hand with respect to the gauge. Optionally, the information received from the remote information source may comprise textural or quantitative data.

In one embodiment, the hand comprises multiple hands and the controller varies the angular or linear offset of each of the multiple bands independently, in response to like multiple different aspects of the remote information.

### BRIEF DESCRIPTION OF THE DRAWINGS

The foregoing and other objects, features and advantages of the invention will be apparent from the more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a system for the ambient display of remote information in accordance with the present invention.

FIG. 2 is a printout of an example of XML-formatted data, illustrating a typical information source data feed.

FIG. 3 is a screen image of an HTML-formatted version of the XML-formatted data of FIG. 2.

FIG. 4 is a screen image of a first exemplary user interface for mapping the electronic data to ambient data, in accordance with the present invention.

FIG. 5 is a screen image of a second exemplary user interface for mapping the electronic data to ambient data, in accordance with the present invention.

FIGS. 6A and 6B are first and second examples, respectively of a user interface for selecting a channel of data to be displayed on an ambient device.

FIG. 7 is a block diagram illustrating the distribution of micropackets from the server, through the communication channel, to the ambient devices, in accordance with the present invention.

FIGS. 8A, 8B and 8C respectively illustrate serial aggregation of micropackets within a packet in accordance with the present invention, random access aggregation of micropackets within a packet in accordance with the present invention, and the conventional approach of sub-addressing within a packet.

FIG. 9 is a front view of a gauge embodiment of the ambient device, in accordance with the present invention.

FIG. 10 is a front view of a swappable face card for the gauge embodiment of FIG. 9, in accordance with the present invention.

FIGS. 11A through 11F are front views of gauge embodiments, illustrating the utility of the swappable face card, in accordance with the present invention.

FIG. 12 is a front view of a gauge embodiment, illustrating light emitting diodes at the tips of the hands for conveying additional information in ambient format, in accordance with the present invention.

FIG. 13A is a block diagram of the components of a wireless gauge ambient object, in accordance with the present invention. FIG. 13B is a block diagram of the components of a wireless orb ambient object, in accordance with the present invention

### DETAILED DESCRIPTION OF PREFERRED EMBODIMENTS

The present invention is directed to methods and systems for translating remote information from the outside world, and presenting the translated information to a user in the form of an ambient information display or object. Instead of the burdensome computing and physiological sensing involved with intelligent agents described above, ambient information display takes advantage of a human's ability to monitor several information streams, while only attending to the most significant one.

As an example, while driving, one can speak with a passenger in the next seat while still paying attention to the road, vehicle location, erratic or threatening drivers, as well as monitor dashboard gauges that indicate how much gas is in the vehicle and engine temperature, and other readouts on the dashboard. If the vehicle is low on gas, or if an aggressive driver crowds one's space, attention will naturally shift from the conversation to the driving task. Humans have evolved to efficiently make these sorts of transitions without distraction.

By connecting widely available standard-formatted digital information to the types of physical objects humans are accustomed to having in their environments, a rich source of information tapestry can be created. Using wireless technology, a gauge can be wirelessly connected to external information such as the stock market, weather forecast, or traffic conditions and effortlessly monitored. The representations can be much more subtle and organic. For instance, the sound of rustling leaves can indicate wind. But using ambient technology, the rustling sound can be used to indicate any type of digital information, such as accumulation of email. Just as humans can hear rustling leaves and think “wind” without becoming distracted, the same is true for all kinds of information. Continuing this example, humans can quickly learn that the sound of rustling leaves corresponds to “rain forecast for tonight”.

Ambient information display covers the ground between information push and pull operations. It is similar to the manner in which information is acquired from a clock. A clock represents both information push and pull operations in that it continuously displays (pushes) the time, yet requires a minimal amount of user intervention to glance at the clock and observe (pull) the time. Analog clocks display their information in such a manner that humans can typically acquire the time without causing an interruption or pause in their mental flow The act of reading time is performed by what psychologists refer to as “pre-attentive awareness”. If the displayed time is more significant than the current focus of attention (e.g. it's getting late), the time will become the new focus of attention. The human brain is generally very efficient at focusing on a single task while still being aware of other tasks, and switching attention to the other tasks when appropriate.

Pre-attentive awareness refers to the human ability to recognize visual features without cognitive loading. A visual recognition task may be considered pre-attentive if some or all of the following factors apply: 1. Visual task can be performed in under 250 ms; 2. The length of the task is not affected by increasing number of distractions; 3. Several tasks classified as pre-attentive can be performed in parallel; 4. Absence of conscious awareness; 5. The ability to perform a concurrent task without adversely affecting the performance of either task. Clearly, analog (dial-type) clocks meet the criteria for pre-attentiveness. One can glance at a clock without being distracted by the clock or turning attention from the foreground task. While the above examples of pre-attentive awareness are with respect to vision, similar functionality exists for all human senses.

Ambient devices have the potential to convey many different types of information in a manner that is as easy to reference as time. In one example of the present invention, wireless networks are made to communicate with remote ambient devices that display information, for example, by changing color, form, shape, or motion. For instance, instead of the hands of a clock representing hours, minutes, and seconds, they could instead be used to represent the daily, weekly, and monthly price of a stock, or the temperature of three different vacation locations. Wireless networks and standardized information enable all kinds of devices to be as unobtrusive, yet as functional, as a clock.

The effectiveness of ambient devices is based on the premise that humans can absorb information through many different media such as sight, sound, touch, and temperature. Current information technology presents information exclusively through textual or verbal (printed or spoken) representations that must be consciously acquired to be useful. Ambient awareness takes advantage of the peripheral, pre-attentive awareness, such as the manner in which clocks are noticed, or the manner in which one hears his or her name in a crowded room, to acquire information.

The MIT Media Laboratory has created a demonstration of ambient media in the form of pinwheels that spin faster or slower in response to up or down trends in the stock market. Users in the presence of these pinwheels have an awareness of the stock market, without the distraction of having to watch TV, listen to the radio, or go online However, the pinwheel demo described above is impractical for widespread distribution, since the data translation is performed locally on the device, on dedicated hardware that is fixed in the construction of the device.

Conventional web browsers such as Netscape™ and Internet Explorer™ connect to a server using the HTTP protocol, then download an HTML information stream. The HTML stream is then formatted for display on the computer's monitor. PDAs, web-enabled cell phones, and other portable wireless devices can also connect to this HTML/HTTP stream. However, such devices format the received information to optimize display on their smaller, and often monochromatic, displays.

Ambient devices can also connect to these information streams. The ambient devices configure the HTML/HTTP stream to be optimal for their particular display. Wirelessly connected ambient devices operate as full-fledged web browsers in the sense that they connect to a digital information stream, and download, process, and display such information.

Ambient devices, however, use pre-programmed rules to translate this textural quantitative information into a non-textural format for ambient display. In general, HTML is designed to contain sufficient information for display on textural web browsers, however, there is no general set of rules by which all kinds of digital information can be translated into ambient forms. Each particular information source requires a customized set of tools to manage this translation. The systems and methods of the present invention provide a convenient and common format for conveying various forms of remote textural information on various forms of ambient devices.

In one example, the present invention provides an ambient device in the form of a glowing orb that can be configured to change color according to percent change of the Dow-Jones stock index. This device can be connected, for example, to a site that offers free 20 minute delayed stock information, download and parse the HTML data, and format the quantitative stock information as a single, continuously changing color and/or animation. In this manner, the ambient device and associated system can be thought of as a “single pixel browser”. Through an ambient change in color and/or animation rate of a single pixel, the glowing orb displays valuable information which makes a user aware of market fluctuation, but relieving the user of irritating interruptions. The user can continuously observe the changes of color, and can decide to take action whenever the change or trend becomes significant with respect to his or her current cognitive load.

A key feature of an ambient display is that a user can decide to take action before the monitored event becomes critical. With the conventional push alerts described above, the conveyed information transitions from invisible to urgent without intermediate graduations. Ambient information display, on the other hand, offers continuous updates, allowing the user to remain aware of changes, and preparing the user should intervention become necessary. This process is referred to as “pre-escalation awareness”. The process of ambient observation of such information is referred to herein as “frictionless information awareness” since an observer can be exposed to the information without the information causing additional mental clutter or distraction.

While it is possible for the ambient devices to be connected directly to HTTP/HTML servers as described above, in a preferred embodiment of the present invention, a dedicated information server is employed to mediate the interaction. A translation is performed by the server to convert the quantitative/textual information to ambient information that is optimized for display on an ambient device, in a centralized, controlled environment. This conversion can be accomplished according to Web-configurable user preferences, and the converted, ambient information can be transmitted from the server to the ambient device in a compact and computationally straightforward format. Pre-formatting the transmitted data in this manner, greatly reduces bandwidth costs, and reduces the computing power required in the remote ambient device. Furthermore, placing the configuration engine in a centralized server facilitates the addition of new information channels without having to modify the remote ambient device.

The systems and methods of the present invention may further include a dedicated ambient information server which allows for Web-based, user-configurable control of the ambient devices in a standardized web interface, as described above.

While the ambient display of remote information is greatly facilitated by the emergence of standardized wireless networks, the converted, ambient information generated at the server can be transferred to the remotely located ambient devices by wired means, such as a dial-up Internet connection, a telephone line, broadband (DSL, cable) or commercial T1 line. In many settings, a wired ambient object has the same potential to frictionlessly convey information as its wireless counterpart.

The ambient information server of the present invention provides an infrastructure for acquiring, configuring, and disseminating online digital information in ambient form to a plurality of ambient objects.

The ambient server performs at least two primary functions. First, it provides user interfaces for configuring the display of the ambient information at the ambient object. Such interfaces allow a user to configure the information source fed to the associated ambient object, as well as various parameters affecting its display of the information . The ambient information server further operates as a gateway to collect the data, to translate the data from textural form to an ambient form appropriate for ambient display, and to broadcast this data to the remotely located ambient device. In a preferred embodiment, the converted and broadcasted ambient data is much more compact and efficient to transport than its verbose textural equivalent.

Note that although such ambient objects may be referred to herein as ambient “displays”, the systems and methods of the present invention encompasses ambient devices that convey or present information using means that are not necessarily visual. For example, auditory means, and physical means such as force or friction may be employed. Any of a number of ambient display form factors are possible. Example embodiments include an ambient gauge display, a glowing orb and a spinning nautilus. The principles of the present invention are in no way limited to these form factors and other form factors disclosed herein.

Much like a clock, a barometer or gauge includes several hands of different lengths, shapes, and other distinguishing features. Furthermore, indicia on the face of the gauge provide calibration marks to help the user translate between angular offset of the hands, and the value of the information contained. In the case of a clock, the information conveyed is time. For the ambient gauge display of the present invention, the information conveyed may comprise any available information available in digital format, whether personal or public. Unlike a clock, data for the ambient gauge display of the present invention is received electronically through a wired or wireless connection. Instead of the hands being controlled by a local mechanical or quartz mechanism, the hands of the ambient gauge are independently controlled by an electronic signal containing specified angular offsets for each hand of the gauge. This electronic signal originates from the ambient information server described above, and can be configured either through an external interface such as a Web interface or touch-tone phone, or through a local interface on the ambient gauge housing itself, such as dials which allow for selection of a zip code for geographically relevant data.

In one embodiment, swappable printed gauge faceplates are employed. The gauge unit detects which face has been inserted, and adjusts the angular offset of the hands to represent the information signal associated with that face. For instance, one face may convey stock market information while another face conveys forecasted temperature. This feature allows a great deal of flexibility and customization without having to use a computer, PDA, or any electronic device for online web configuration. In this manner, changing the information displayed is as simple as removing one face and replacing it with another. Regardless of whether the configuration interface of the gauge is local (swappable faces, dials) or web based (via a web browser), a key aspect of the gauge of the present invention is its ability to receive information from a remote server and to display the information in ambient form.

In another embodiment, the face of the gauge may comprise an LCD screen that can be reprogrammed so as to change the indicia and calibration marks represented thereon. A gauge having such an LCD screen may include traditional, physical hands in order to provide a traditional clock-like or barometer-like appearance, Optionally, rather than physical format, the hands of the gauge may also be in virtual format, represented on the LCD screen in an image form.

In the glowing orb example, information is translated into color through the modulation of light. Local configuration may be as simple as a brightness control and reset button, while 5 remote configuration via a Web interface allows a user to select between information sources and different modes of display. Alternatively, the glowing orb may be configured locally, in the same manner as the gauge, for example through the use of dials or swappable printed or electronic media.

In the spinning nautilus example, information is translated into directional motion. In one example, a nautilus shaped shell is mounted to a motor that can vary in direction of rotation.

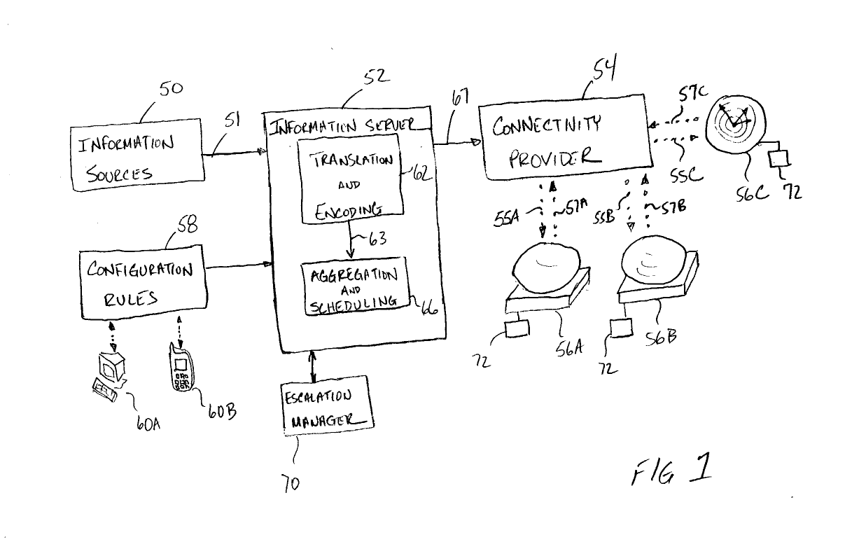

Information such as a rising or falling stock market indicator can be translated to ambient form, for example by causing the nautilus shell to spin in a clockwise or counter-clockwise direction, depending on the configuration, which can be remotely or locally controlled, as in the other examples. The systems and methods of the present invention will now be described with reference to FIG. 1.

An information server 52 receives and manages information in the form of digital data 51 from an external information source 50 or a plurality of such sources. For example, such data may comprise data related to traffic, stock performance, weather, pollen, email accumulation, sports scores, status of a family member, status of a home alarm, and the like. As explained above, there are a growing number of companies that make such information available on the Web in digital format.

Alternatively, such information in the form of digital data 51, may comprise user-customized data provided by a user in electronic form. A vast array of information can be conveyed in pre-attentive, ambient format. For example, data related to the following topics can be conveyed by the ambient object: financial data such as stock/bond performance, mortgage rates, debt ratings, any data element electronically available on financial data pages; sociopolitical data such as Union of Concerned Scientists “Nuclear Countdown” clock indicator, national debt data, income disparity metrics, literacy rates, infant mortality rates, Amnesty International statistics on human rights, rights for women, etc., donation amounts; meteorological data such as weather forecasts and current conditions; public health-related data such as pollen forecasts and flu virility forecasts; personal data such as quantity/age of voicemail or email., number of buddies logged into Instant Messenger, moods, availability of a co-worker spouse or friend; business-related data such as inventory levels, customer satisfaction, profit, utilization rates, sales, Web traffic; hobby-related data such as auction site price sell/buy/volume, lottery data, betting odds, horoscope/lucky color, snow/hiking/sailing/fishing/outdoor recreation conditions; travel-related data such as traffic conditions; airport delays, and cost of airline/train/bus ticket; personal health-related data; and news-related data such as the number of keyword matches on favorite news website, newsgroup activity, etc.

Ambient devices can also be of utility for healthcare situations. Ambient awareness can help involve family members and other non-professional family members in the home monitoring of ongoing chronic medical conditions. For instance, an elderly man is diagnosed as hypertensive (high blood pressure). He is sent home with a blood pressure cuff and told to take readings twice per day, and record these readings in a log book so trends can be analyzed.

In an ideal world, this would present both patient and doctor with a detailed and accurate description of health. Unfortunately few patients are sufficiently organized to record this detail, and even fewer doctors have the resources to analyze the trends.

Wireless blood pressure cuffs which transmit the information to a web server are technically feasible. Once this information is present on the web in electronic format, to an ambient information server, it looks just like any other data such as traffic or weather.

Ambient display of medical information is useful for several reasons. For the patient, it can aggregate and summarize readings from multiple devices at multiple locations. With conditions such as diabetes, trends and variation in glucose (blood sugar) are as important as the actual readings. Ambient displays can present this medical information in a way that is understandable by a non-professional, giving patients greater control of their health.

Ambient display of health information is also useful for involving non-healthcare officials in the administration of long-term care in home settings. A child can monitor an elderly parent's health without being inundated with details or being overly invasive. A parent is given the opportunity to display virtuous behavior such as drug compliance, exercise, or adherence to a diet—and this opportunity can lead to improved results. Ambient displays therefore have the potential to reduce healthcare costs by increasing the role of non-professional caregivers such as family and friends.

Ambient devices can also create social networks of people sharing health improvement goals such as smoking cessation or weight loss. Organizations such as Weight Watchers™ will often pair participants with a buddy and at weekly meetings the buddies are given a target amount of weight to collectively lose. Buddies utilizing ambient displays connected to wired scales can receive continuous non-interruptive information about weight loss goals, in contrast to one reading per week.

An essential feature of the healthcare scenarios mentioned above is the treatment of health-related online information just like any other type of available information, as a source of information for display on a remote ambient object. These examples are included to demonstrate the wide applicability of the ambient information display

A database manager at the server 52 utilizes administrator tools to control access to the server, associated Web site, and data contained therein. The database manger further performs maintenance tasks such as billing, load balancing, and caching. The administrator tools are further capable of providing statistics on user preferences and click-through behavior.

When the data 51, in digital form, becomes available to the server 52, the data undergoes translation into a form referred to herein as “ambient data” at the translation and encoding unit 62. The translation process occurs in response to rules that are configured, for example by a user of the ambient object or by the manager of the information server.

The resulting translated data is encoded to be optimized for non-textural ambient displays. The translator 62 efficiently utilizes bandwidth to deliver continuous updates to the ambient displays using the smallest amount of data possible. This takes advantage of the ambient format of the information to deliver, for example. a color in the glowing orb example or angular offset in the gauge example, in a very small amount of data.

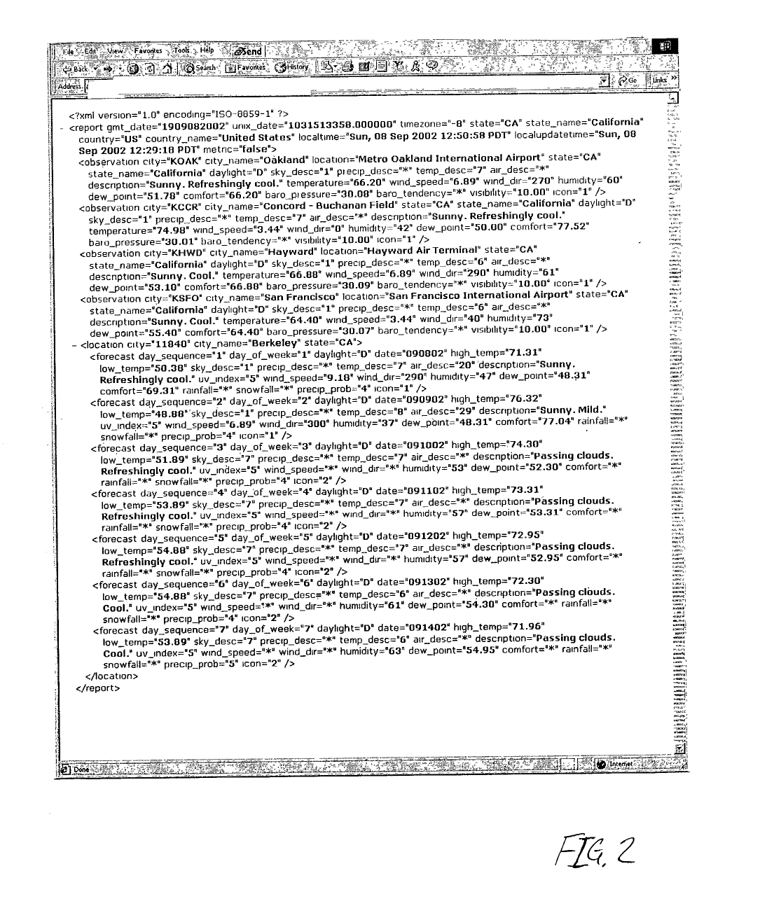

The operation of the translation and encoding unit 62 is described in further detail below with reference to FIGS. 2 through 7.

Following translation and encoding of the data, the encoded data 63 is presented to an aggregation and scheduling unit 66 which accumulates the translated and encoded data 63 destined for multiple remote ambient object 56A, 56B, 56C and schedules the data for eventual distribution by the connectivity provider 54 to the objects 56A, 56B, 56C in a manner that optimizes the economic efficiency of its distribution. In one example, the scheduling of the distribution is periodic, for example, once every 15 minutes during the day, and once every hour at night.

The scheduled data 67 is then transferred to the connectivity provider 54. The connectivity provider 54 may comprise, for example, a wireless data transmission network, or a wired Internet-based, or telephone-based link. The connectivity provider 54 receives the scheduled data 67 and transfers the data to the remotely located ambient devices 56A, 56B, 56C via a one-way communication channel 55A, 55B, 55C, or via a two-way communication channel 57A, 57B, 57C.

The ambient display units 56A, 56B, 56C receive their respective encoded data and update their respective displays accordingly.

FIG. 2 is a listing of a typical data feed 51 from an information source 50, as available from a data provider on the World Wide Web. While this data is readable by humans, it does not contain any graphic design elements or other cues that make it easily readable. This data has been formatted with standardized XML (Extensible Markup Language) tags for easy parsing by a computer. Such XML-based formatting makes the data amenable to use by web servers which format the data for more suitable human observation.

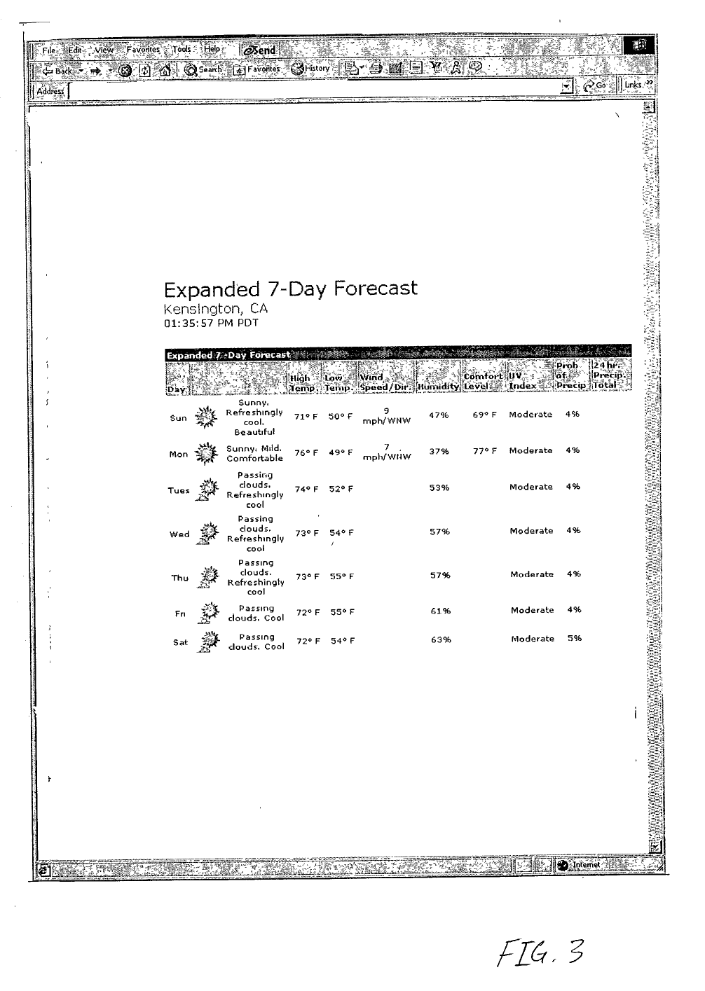

FIG. 3 is a screen image of an HTML-formatted version of the XML-formatted data of FIG. 2 as typically displayed at a Web site. The textural elements of the XML-formatted data have been reproduced on the HTML-formatted graphical page, and numeric icon designations have been converted into pictures. The display makes it much easier for a human to retrieve relevant information, but from an information standpoint, the data presented are essentially equivalent, and thus the translation is reversible

Since the ambient displays of the present invention are non-textural, the XML data of FIG. 2 is translated, or mapped, into a signal appropriate for the ambient display device, in response to a set of rules, or parameters, that may be user-definable, or otherwise set by the information server. Such mapping can be accomplished with a web interface, as illustrated in FIG. 4.

FIG. 4 is a screen image of a first exemplary user interface for mapping the electronic data to ambient data, in accordance with the present invention. In this example, information in the form of weather data of a particular city is mapped to a color that is displayed on a glowing orb ambient device.

With reference to the screen image of FIG. 4, a user can modify the city being monitored by providing a city name or a zip code in combo-box 102. Users can select a range of meteorological phenomena from combo-box 104, for example, average temperature, high temperature, low temperature, UV Index, wind speed, humidity, dew point, and precipitation probability. The forecast period is selected in combo-box 105. Options include: today, tomorrow, 2-days, 3-days, 4-days, and upcoming weekend. In entry box 106, a user chooses the color palette onto which the meteorological phenomenon is to be mapped. In entry box 108, a user enters the numeric values for the upper and lower limits of the palette selected in entry box 106. Checkboxes 110 and 112 allow a user the option to display an additional layer of information beyond color through an animation. For example, the orb can be programmed to pulse if precipitation is forecast, with the pulse rate proportional to the likelihood of precipitation. Alternatively, a “heartbeat”-type pulse can be selected if the National Weather Service has issued an advisory or warning.

The data translation and encoding unit 62 (see FIG. 1) is, for example, in the form of software operating on the server that receives the user-defined configuration parameters, or rules 58 (see FIG. 1), and processes the XML input data into an encoded ambient data packet—referred to herein as a micropacket. For the glowing orb example, this micropacket is quite small—merely 2 bytes in length. For the gauge example, the micropacket is three bytes in length. The encoded bytes contain programming information specific to the device, for example the color to be displayed, intensity, animation mode, and the like. A preview of how the user's orb will appear upon receipt of the micropacket is pictured in window 114.

FIG. 5 is a screen image of a second exemplary user interface for mapping the electronic data to ambient data, in accordance with the present invention. In this example, information in the form of stock portfolio data is mapped to a color that is displayed on a glowing orb ambient device. With reference to the screen image of FIG. 5, a user can modify the stocks in the portfolio being monitored by providing a stock symbol and number of shares in entry boxes 120 and 122. In entry box 124, a user chooses the color palette onto which the portfolio performance is to be mapped. In entry box 126, a user enters the numeric values for the upper and lower limits of the palette selected in entry box 124. Checkboxes 128 allow a user the option to display an animation. For example, the orb can be programmed to pulse if the change in portfolio value exceeds the limits chosen.

The illustrations of FIGS. 4 and 5 are provided by way of example only and in no way limit the present invention as claimed. One can conceive of a wide array of form factors of ambient devices that are equally applicable to the principles of the present invention. It should be noted that each ambient object form factor has a slightly different web interface—for example, the user interface for the orb is not necessarily suitable for the gauge embodiment. Since the gauge includes hands that vary in angular offset, rather than color, the gauge requires a different web interface to select mapping between information and display, and the micropackets of ambient data that are transferred to the gauge are in a slightly different format so as to convey the angular offset information, mode of animation, and the like.

In one example, users of the orb ambient objects register an orb with the information server using a serial number. Following registration, registered users can then control the information that is transmitted to their respective orb.

Accounts granted to registered users can vary in flexibility and features, depending on the level of service. For example, accounts can range in flexibility and cost—ranging from “free” accounts offering a basic level of service, to “premium” offering a sophisticated level of service and control. At the basic level, a free account may permit a user to change between the type of information, or channel, the server is pre-programmed to broadcast, for example stock index information (i.e. Dow-Jones, NASDAQ, S&P 500, Russell 2000), tomorrow's temperature in major cities, or the current threat assessment level from the newly created Office of Homeland Security. In addition to being restricted to the information being broadcast, users of such free accounts may not necessarily have the ability to change the tolerance of the information. For instance, the free DOW broadcast may have settings that are fixed at upper and lower limits of −1.5% and 1.5%. Free account users cannot change these tolerances. However, if a given information micropacket is offered with different tolerances, users of free accounts have the option to select between such free channels.

Finally, users of such free accounts may be required to initiate a reprogramming process each time they select a different channel. For example, assuming a given orb device employs a 1-way wireless network, a user of that orb must manually confirm that the orb has received the signal instructing it to decode a different micropacket. For example, under such a reprogramming configuration, an orb can be are programmed to turn a dim blue color when it receives a signal instructing the orb to change to receiving a different micropacket. This gives the user the necessary feedback to determine that the orb channel switch has been successful. (2-way wireless systems offer the ability to transmit a confirmation signal back to the server, making channel switching more invisible to the user).

At a high level of service and sophistication, users of premium accounts may pay a monthly service fee for a dedicated micropacket containing whatever information is desired. For example this micropacket may comprise a dedicated segment of a wireless data packet. In one example, this means that a premium customer will enter a reprogramming procedure only once when switching to this micropacket, but never again. Once the orb is programmed to the custom micropacket, the act of changing channels of information to be received, (or changing the parameters of a given channel) simply changes the contents of the micropacket being aggregated, scheduled and transmitted to that user; reprogramming has no effect on which micropacket is designated for that particular orb. This is in contrast to channel changes under free accounts, under which the orb is instructed to change to a different routinely broadcast micropacket when a different channel is selected.

The ambient data in the form of a micropacket thus contains merely display information. The micropacket contains no knowledge of the source of the data—it simply instructs the ambient display with regard to the manner in which to present the information. For example in the orb example, the micropacket instructs the orb with regard to which color it should be, and any associated animation. The server is responsible for translating the textural data into this color according to rules programmed in the translator unit 62 (see FIG. 1). This means new data channels can easily be added, provided an interface or means for translating textural data into ambient data is provided. No configuration or software needs to be changed at the remote ambient object.

Users can optionally utilize a website interface to change the information channel that is transmitted to their display devices. Users with premium accounts can also configure details within each channel as described above. It is important to note that while users of broadcasted, free accounts are not necessarily offered these configuration dialogs, such configuration dialogs play an essential role for free account users. The channels that can be selected by free users are preferably configured by the same configuration interface. The only difference is this that this configuration is not exposed to the end users of the free accounts, but administered by the service provider who makes decisions about what types of data to broadcast.

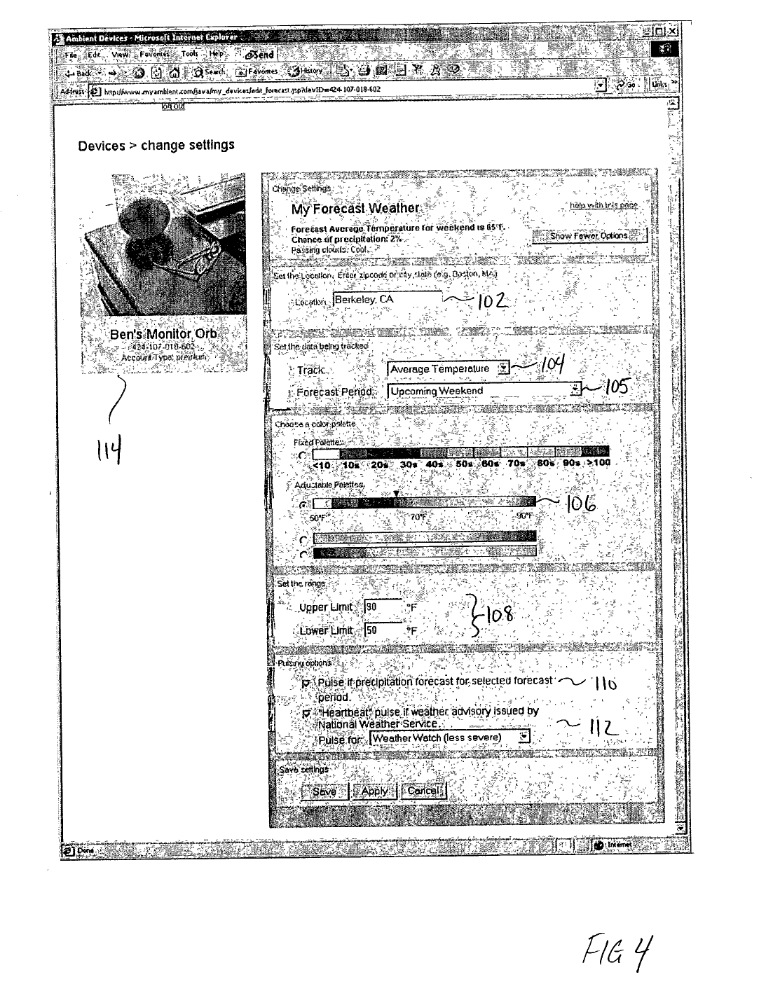

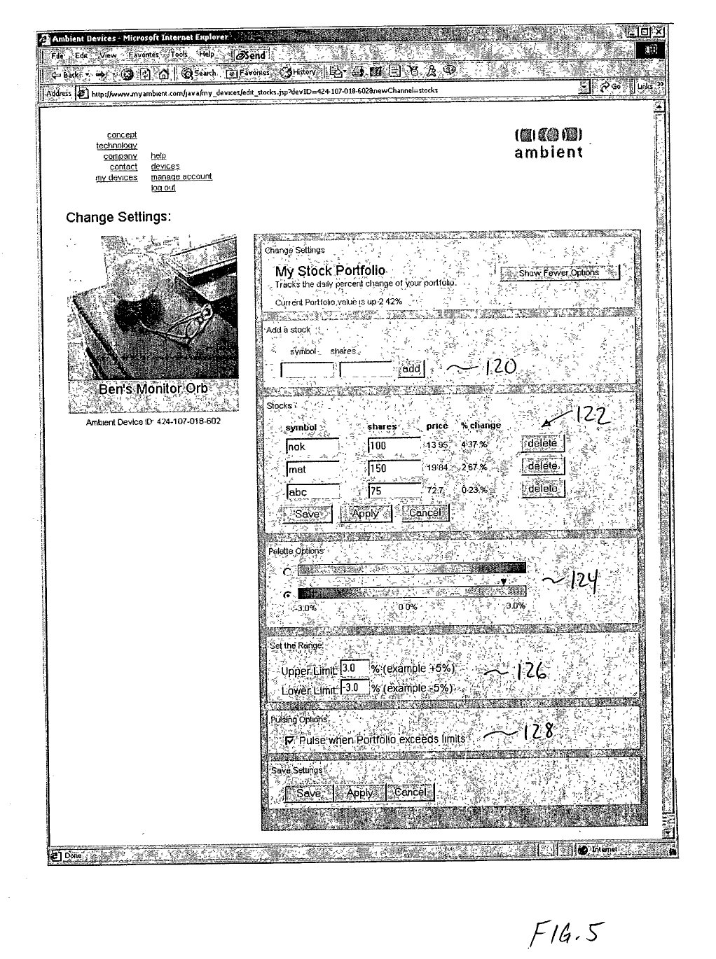

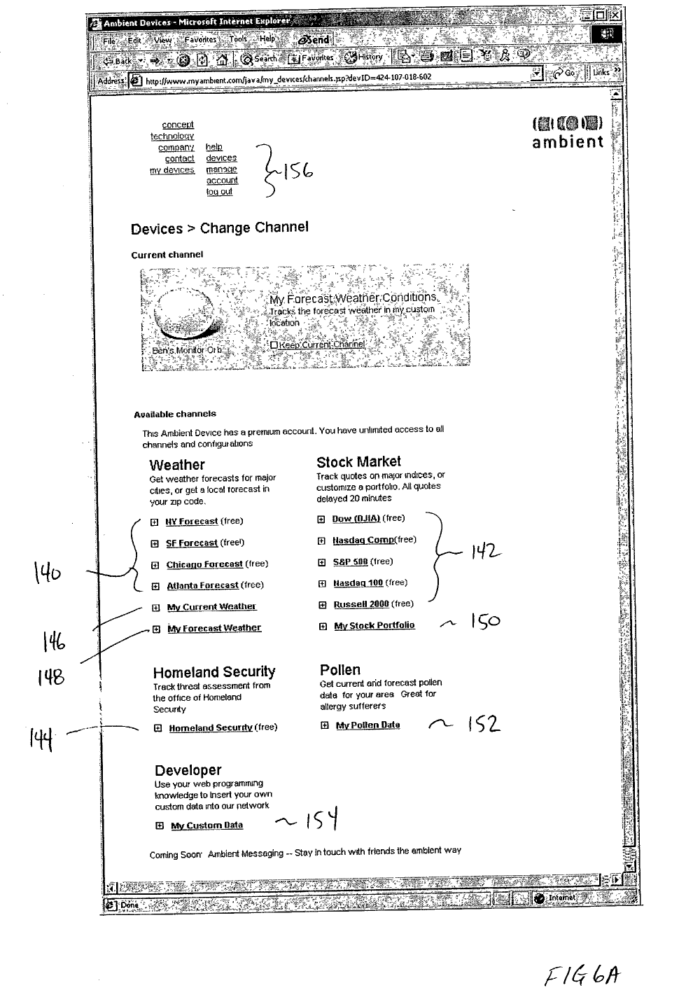

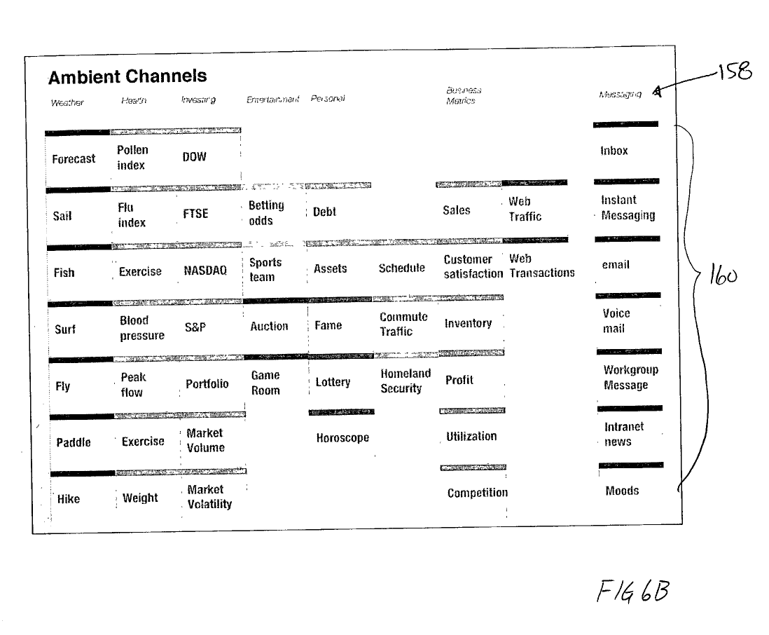

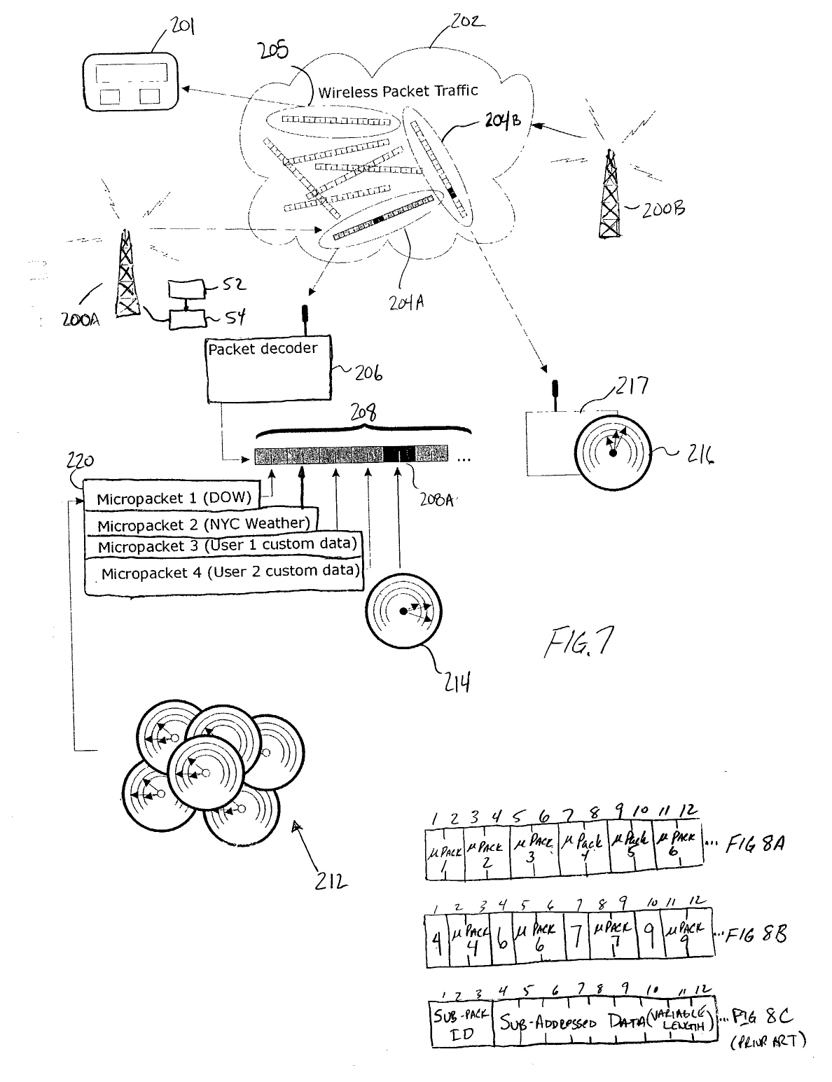

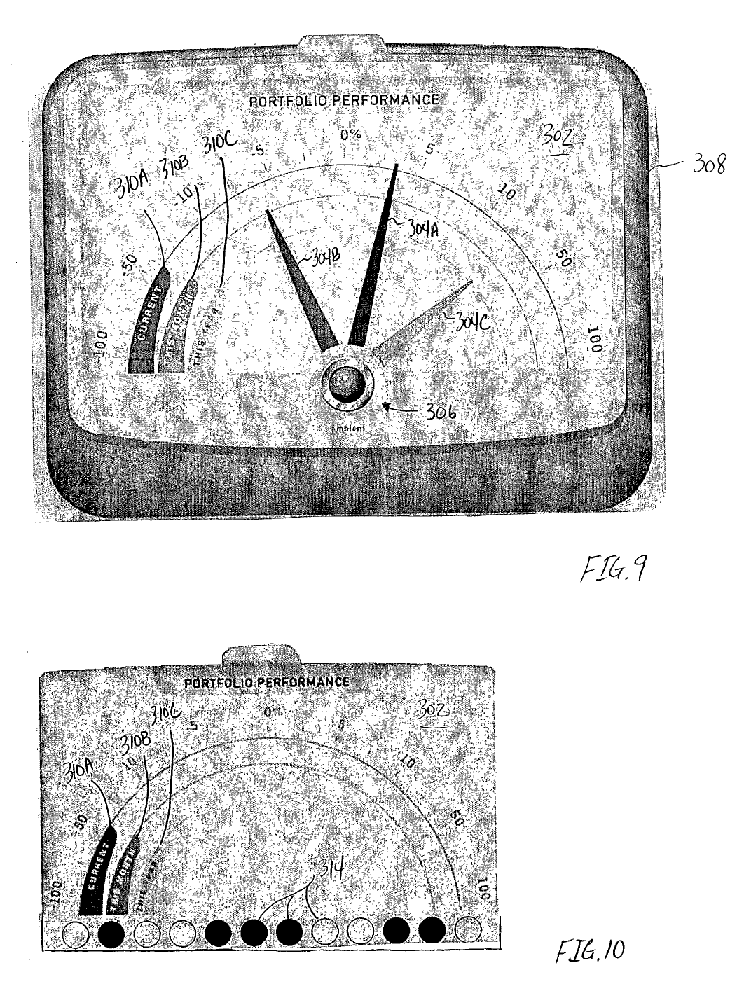

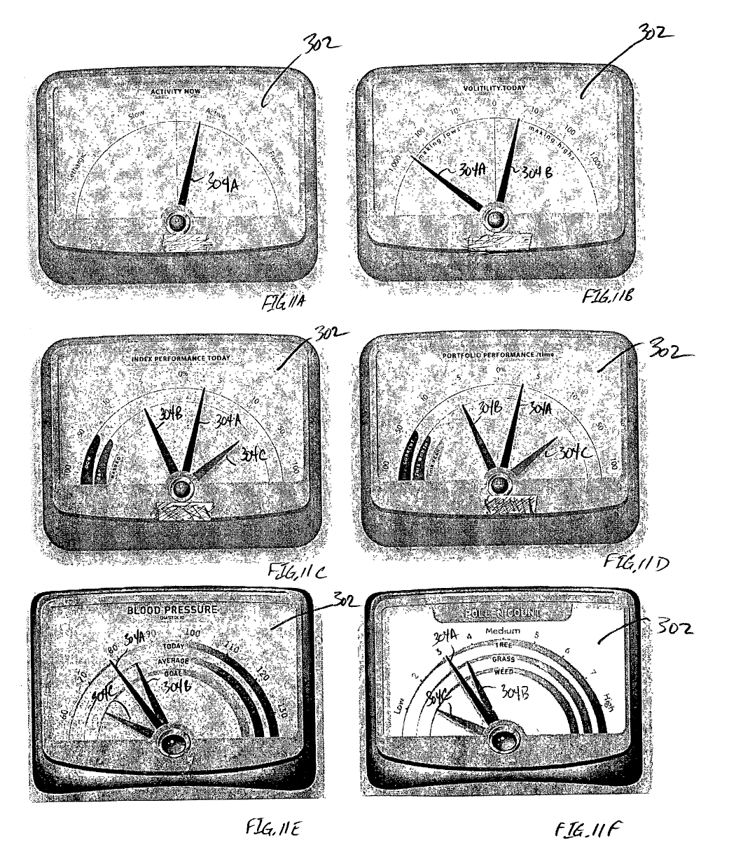

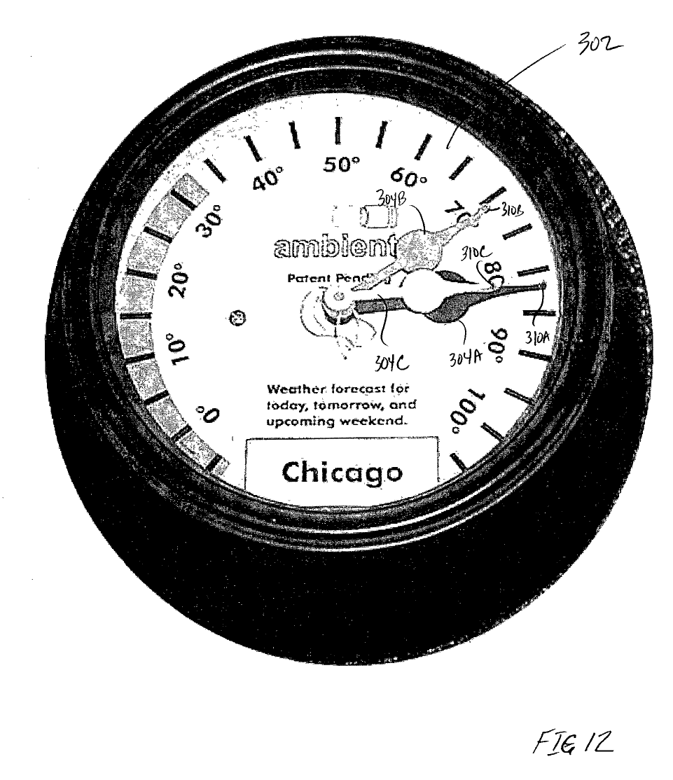

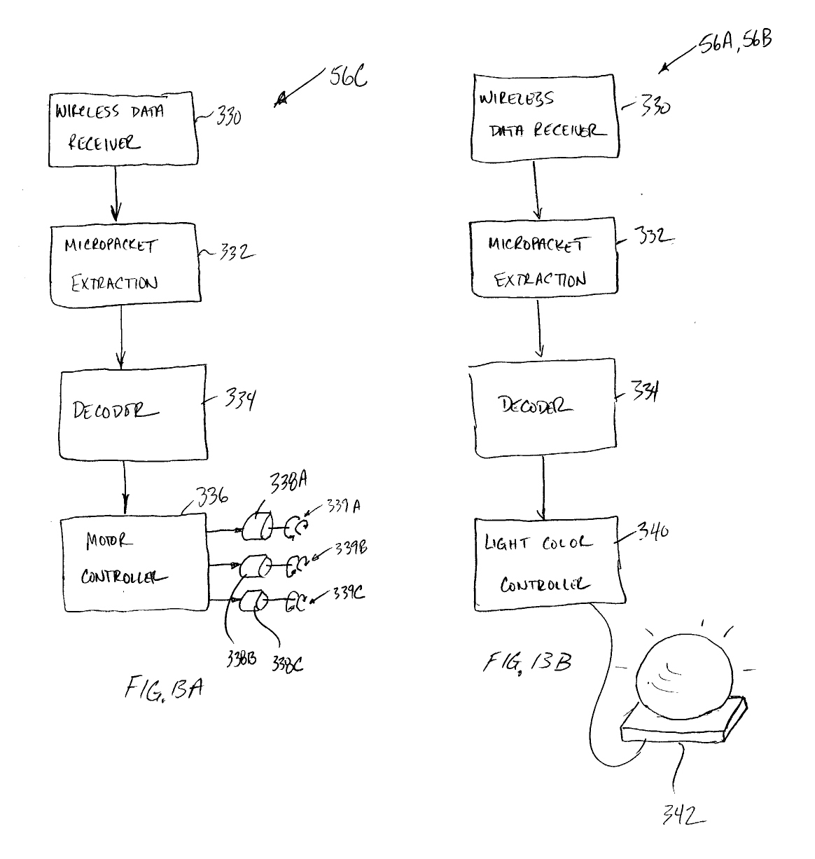

Example interfaces for channel selection are shown in FIGS. 6A and 6B In the example of FIG. 6A, a premium account user, “Ben”, has the option of selecting the channels of several free, broadcasted, micropackets of weather information 140, stock market information 142, or threat assessment information 144. Ben also has the option of selecting among one or more customized channels that were previously pre-programmed by Ben, for example, Ben's current weather 146, Ben's forecasted weather 148, Ben's stock portfolio 150, and pollen count for Ben's region 152. Any of the customized channels can be re-programmed by Ben via the Web interface. In addition, Ben can directly control the output color of the orb using the “Developer” channel. This allows users to employ their web programming skills to add any electronically available information, public or private, to the ambient network. Ben further has the option of managing his account or seeking help 156 under the Web interface.

The example of FIG. 6B provides another option as to how the channels of a user's account can be selected and managed. A number of topics 158 for example, “weather”, “health”, “investing”, “entertainment”, “personal” are listed across the first axis of a chart, and the channels 160 associated with each topic are listed down the second axis of the chart. Any of a number of such user interfaces are equally applicable to the present invention.

With reference to FIG. 1, the remotely located ambient objects 56A, 56B, 56C can be configured via a web-based computer interface 60A, or optionally through non-web-based interfaces such as touch-tone phone or voice interface 60B, or a live person operating the web interface. The important feature of any configuration process is the ability to provide a set of rules to the translation and encoding unit 62 for translating the textural information into ambient information ready for display by the ambient objects.

After each user's data is encoded into a micropacket by the translation and encoding unit 63, multiple micropackets are assembled by the aggregation and scheduling unit 66 for efficient delivery by the connectivity provider 54. For example, in a FLEX™-type wireless pager system, data packets can range in size between a single byte of data to several hundred bytes. The time-slice format used to transmit pages place an upper limit on the size of a paging packet. While there is no lower limit on packet size, small packets are inefficient to deliver. There is a certain fixed data cost associated with transmitting a packet of data under the FLEX paging system. Less bandwidth is used to send a single 100-byte data packet, than to send 20 5-byte data packets. Because many, if not most, ambient device micropacket encodings under the present invention, will be under 20 bytes in length, the micropackets are aggregated into a single packet, and each remote ambient device is configured to listen to, or receive, a specified segment of that packet including the expected micropacket of data.

For example, the aggregation unit 66 can be programmed to sequentially assemble the two-byte micropackets required for orb device programming into an 80-byte data packet, which is optimally sized for efficient transmission under the FLEX paging network. Under this example, a single 80-byte FLEX packet can therefore contain data for up to 40 unique orb device configurations. These full-packets are then scheduled for transmission on a fixed schedule, for example, ranging in periodicity of once every 15 minutes during the day, to once every hour during the night.

Aggregation of the micropackets into packets of data for transmission is much more efficient than transmitting individual data packets to each individual remote ambient device. More sophisticated aggregation and scheduling approaches can, for example, take into account additional parameters such as how much the data has changed, how urgently the data needs to be updated, what level of service the user is entitled to, and what type of coverage is available to the user. The algorithms used by these more advanced aggregation and scheduling approaches will further optimize the transmission of the micropacket ambient data in environments where connectivity costs are nonzero.

Because the nature of ambient device output is often analog, lossy compression may be appropriate in certain situations. This would allow even greater data compression, and even smaller micropackets for programming the devices. Because ambient information is typically analog, small errors in decompression will not significantly affect the accuracy of the ambient display.

The aggregation and scheduling unit 66 may also make intelligent decisions about when to re-arrange device micropacket designations within a packet in order to reduce bandwidth by eliminating duplicate and ignored micropackets. This is discussed in greater detail below.

Once the micropackets have been assembled into packets by the aggregation and scheduling unit 62, the packet is transmitted to the connectivity provider 54. The connectivity provider owns, leases, or has rights to the transmission network responsible for transporting the packets of data to the remote ambient device 56A, 56B, 56C. In one example, the information server 52 employs a standard electronic protocol such as SMTP email or WCTP (Wireless Communication Transport Protocol) to deliver the packet to the server of the connectivity provider, and to verify that the message has been successfully deployed. The information server 52 may also include information with the packet, such as the geographical region to where the packet is to be sent.

The connectivity provider 54 may also comprise a decentralized, distributed network such as the Internet. As explained above, the connection between the remote devices 56A, 56B, 56C and the information server 52 may not necessarily involve any wireless links.

Following transmission by the connectivity provider, the data packet is then received by the remote ambient device 56A, 56B, 56C at receiver and micropacket decoder 72. Using locally stored data, the receiver 72 selectively ignores segments of the packet which are inapplicable to the device, selects the applicable segment, and updates its display based on the ambient micropacket information contained in the applicable segment.

In one example, segment selection may occur by receiving the entire packet of information, and using a locally stored one-byte offset to determine which segment of the packet includes the micropacket encoding designated for that device. In other example, a number of other means are possible by which the segment decoder can be configured to extract other portions of the packet. For example, the one-byte offset mentioned above can be changed to control which segment of the packet should be extracted. In another example, the segment decoder of the device can be fixed at the time of manufacture. This is the simplest approach, but is less flexible in terms of optimization.

In another example, a local configuration of the segment decoder can be provided, such as a set of dials for selecting zip code, or the ability to swap a machine-readable printed insert card that is used to configure the local device. In response to the local configuration, the segment decoder extracts a different segment containing a different device micropacket. In this example, the information server broadcasts a range of packets through the connectivity provider and has no knowledge as to which micropacket any particular device is extracting.

In another example, a micropacket transmitted on a given segment of a packet may additionally contain configuration instructions for altering which segments of the packet are selected by the segment decoder. In this manner, a remote ambient device can be reprogrammed by the information server via the broadcast of suitable protocols. Such server-based configuration operates in the same manner as the local configuration described above, except that the signal to change segments is sourced at the information server in response to a Web-based configuration by the user, rather than from the device. Server-based configuration also provides the server with knowledge as to the number of users that are listening to any particular data configuration.

In another example, a hybrid local/server configuration allows for combinations of local and remote configuration in order to create even more optimized data interaction. For instance, if a user changes a setting local to the device, and this change is transmitted to the server, the server may rearrange micropacket assignments for greater efficiency. If several packets contain micropacket segments that are not being listened to by any ambient objects in the network, the micropackets can be re-arranged to omit the unused micropackets and thus be condensed into fewer transmitted packets.

Micropackets can also be optimized at the aggregation and scheduling unit 66 to eliminate duplicates. If a number of different ambient devices are listening to the same micropacket, fewer transmissions will be needed if all such devices are assigned the same micropacket.

An optional escalation manager 70 (see FIG. 1) allows the user to obtain additional information via a more traditional information conduit, such as a computer monitor or a pager.

This allows an interested user to “drill down” if the ambient device is displaying data that is interesting to the user. For example, the orb form factor example may be provided with a button that controls brightness. However, the button could also be configured (for example via the Web-based interface, or similar) to cause the information server 52 to send a text message to a pager indicating why the orb is in its current state. If the orb is red and pulsing because it is tracking the weather forecast for tomorrow and the forecast is for hot (red) and raining (pulsing) weather, the escalation manager can be programmed to send a text-based message indicating the exact forecast temperature, as well as a brief text description of the weather conditions. In alternative embodiments, the escalation manager can be programmed to send similar messages by telephone, email, facsimile, voice, and the like.

Returning to FIG. 1, each ambient device includes a micropacket decoder 72 that receives packets of data from the connectivity provider. In the wireless example, the micropacket decoder receives a full data packet, and comprises a wireless receiver such as a pager or data modem (GSM). These are devices optimized for decoding packets larger than a typical 2-5 bytes micropacket of the present invention. There are a range of commercially available devices well suited to packet decoding. Typically these devices work by tagging each decoder with a multiple-digit unique ID, and then tagging the packets intended for that decoder with the same unique ID. Because this ID is often 10 bytes, it is more efficient to transmit 80 bytes as a single 80 byte packet than as four 20 byte packets, each with a 10 byte ID.

In one example, the micropacket decoder utilizes the serial position of the micropacket within the packet to determine which micropacket is to be received. Therefore, no additional tagging of the data is necessary. The order of the micropackets within the packet determines how each device decodes its specified micropacket.

Herein lies a fundamental difference between packets and micropackets. Packets are explicitly identified by a unique tag associated with each packet. Micropackets, on the other hand, are implicitly identified by their position within a packet.

In the simplest form, micropackets are identified by a fixed offset within a received packet, however, more sophisticated encodings are certainly possible. Depending on the nature of the data, alternative encodings can be more efficient. For instance, if the data can be guaranteed to contain similar values, the micropacket can consist of a key value and a set of differences from that key value. A single byte for the entire packet can be used to determine if the micropacket contains a collection of absolute values, offset values, or a combination of both.

There is also the possibility of lossy micropackets where the broadcast and received packets are not the same. As long as the nature of the loss is constrained and understood, this could lead to dramatic decrease of bandwidth load. For example, JPEG image compression is lossy, but the loss is constrained to physiologically imperceptible elements of the image. Similarly, a compression scheme could be implemented that maintains the human physiological impact of an ambient device, but does not necessarily transmit the micropacket with perfect fidelity.

FIG. 7 is a block diagram illustrating the flow of communication of micropackets from the connectivity provider 54 to the ambient devices 56A, 56B, 56C. Assembled full packets 204A communicated from the information server 52 to the connectivity provider 54, in this case a wireless connectivity provider, are transmitted by a wireless carrier 200A. These ambient-based data packets 204A, 204B are transmitted along with non-ambient data 205 from traditional wireless carriers 200B for reception by traditional text-based wireless devices such as pagers 204. Packet decoders 206, 217 for the ambient devices 212, 214, 216 listen for matching data packet. 204A, 204B. An ambient object 214 connected to that packet decoder 206 then inspects its specific micropacket 208A. Other devices 216 on the network also listen for their respective packets and micropackets. Popular micropackets 220 can also be listened to by arbitrarily large groups of devices 212.

In the example of FIG. 7, the first two micropackets of packet 208 contain ambient data related to the Dow Jones Industrial Average (TM) index (micropacket 1), and the forecast high temperature for tomorrow in New York City (micropacket 2), respectively. IN this scenario, these micropackets are available to any owner of an ambient device. Much like radio or TV, these micropackets are broadcast for anyone with an ambient device to decode.

The packet 208 also contains private micropackets (Micropacket 3 and Micropacket 4) which are programmed by individual users, or groups of users, for their own purposes. While public users could conceivably switch their devices to these private micropackets, the data will have no meaning to public users. Users without proper access are restricted from the ambient information server configuration 58, so non-privileged users have no way of interpreting, for example, a blue orb. Publicly available micropackets have meaning insofar as the data they represent is fixed by the ambient service provider. Unauthorized switching to private micropackets is discouraged by not providing interfaces to allow this change. Furthermore, by assigning each ambient device a unique ID known only to the ambient information provider, micropackets intended for that device can be encoded with this unique ID, making that packet appear like random data to a device without the correct unique ID. As the system of FIG. 7 increases in size and complexity, entire packets could be dedicated to exclusively public or exclusively private data. There is no need for a packet to contain any special combination of public and private data, although such a combination is certainly possible.

It is important to note that some wireless networks are 1-way, meaning that they are capable of only of the transmission of data in the direction from the central server to a device, while other networks are 2-way, meaning that the device can communicate back to the server.

1-way devices are simpler to build because they do not need to transmit, and therefore cost less. 1-way devices also consume much less battery power. However, the particular locations of 1-way devices cannot be determined on a wireless network. Therefore, a packet intended for a particular 1-way device must be broadcast to in every cell in which the device could possibly be situated. In the case of nationwide United States paging, this means broadcasting the data packet to every pager tower in the United States.

In contrast, 2-way devices can announce themselves to the network. This means only the communication tower for the cell detecting the presence of the device is required to transmit information packets intended for that device. This is much more efficient because it only consumes the bandwidth of a single cell tower, instead of an entire network of towers.

Aggregation of the micropackets into common packets increases efficiency for the broadcast of packets from the network to more than one remote device. This operation does not necessarily provide any gains for the reverse transmission of data from a device to the network because there is generally only a single network with which the device is in communication. 2-way networks do not change the potential efficiencies of aggregation of micropackets. 2-way networks simply provide the information server 52 with additional information regarding the location of a device. This information can be used to restrict the geographical area to which the packet is broadcast.

There are several techniques for acquiring the geographical location of a device in a 1-way network in order to restrict the broadcast of data packets to a smaller number of cells. For example, the user can be asked to visit a website and enter an address or zip code where the device is being operated. Alternatively, a “trial and error” approach can be used where the user provides feedback as to whether or not the device has received a signal. In this manner, the 1-way devices can gain the same geographical efficiencies as 2-way devices.

This is not to say 2-way networks are without their advantages. For example, 2-way devices can send a signal to the information server indicating the ambient device has received a packet. This is useful if the information is critical. Similarly, if a device cannot be located on the network, the information server can cease attempts to send data to that device.

2-way connectivity further allows local configuration interfaces situated at the ambient device to send this information back to the server, customizing the data the server sends to that device. However, if the user is choosing between data already being broadcast throughout the network, the local configuration only needs to change the packet and micropacket to which the ambient device is listening. There is no need to communicate this interface change back to the information server. Locally situated device configuration interface changes only need to be communicated to the information server if the user is requesting data not already being broadcast.

Remotely situated devices can do more than just display data. They can also collect data, which, in a 2-way network, can be transmitted back to the information server. This data can be transmitted to another device, or used to modify the data sent to that device. For example, an ambient device with a proximity sensor could transmit feedback data to the information server as to whether a person is situated within three feet of the ambient device. This data can then be transmitted to a second device, providing the user of the second device with information about the location and status of the first user. To the ambient server 52, personal information gathered by an actual device is no different than any other data feed.

When a 1-way device is first activated, it has no data to display (the last packet received may possibly be stored in memory, but this data could be old and stale). The 1-way device must wait for the periodic transmission of data from the server before information can be displayed. With 2-way networks, the device can actively request fresh information from the network, greatly reducing the latency between activating a device and it receiving fresh information.

As explained above, escalation refers to the ability for a user to “drill down” and request additional facts about the information displayed by the ambient device. This drill down information will typically take the form of textural data appearing on a nearby pager/cell phone/PDA display, a voice phone call to a nearby phone, or a web page. Escalation is certainly possible on a 1-way device if the user visits a web page or dials a phone number. However, 2-way networks allow the escalation request to originate from the same device used for display. The rules for escalation are configured, for example, via a web interface, telephone interface, or similar means to control the manner in which users configure the translation of textural information to non-textural information.

FIGS. 8A, 8B and 8C illustrate serial aggregation of micropackets within a packet, random access aggregation of micropackets within a packet, and the conventional approach of sub-addressing within a packet. Many 1-way pager companies currently employ a technique known as “sub-addressing” to allow a single pager account to service multiple pager devices. With reference to FIG. 8C, the sub-addressing operation assigns each device a unique ID. Packets preceded by this unique ID are decoded by the device, while other packets are discarded. Therefore, a distinct signal can be sent to each of several devices without the expense of separate paging accounts for each device. With sub-addressing each packet of data includes a single sub-packet. Current sub-addressing implementations do not support multiple sub-packets intended for different multiple devices to be aggregated into a single packet transmission. Sub-addressing does not decrease or optimize the amount of data sent by the paging operator. Because most paging operators charge a minimum fixed amount for a pager account regardless of the number of pages sent, there is an economic incentive to send more pages from fewer accounts. Micropackets actually increase the efficiency of the transmission, allowing more data to be transmitted with less overhead.

For the micropacket aggregation approach of the present invention, the relevant portion of the packet is intrinsically encoded into the structure of the packet, but not anywhere in the actual content of the packet. In one example, the designated micropacket segment for a given device is simply a 1-byte number containing the serial offset into the data packet. This example is provided in FIG. 8A. In this illustration, the numbers 1-12 represent the data bytes received in the packet in serial order. Each micropacket in this example—uPack1-uPack6 occupies two bytes each of the packet. The receiving ambient device receives the packet and is programmed to count micropackets until the designated micropacket arrives. All other micropackets are discarded.

In the example of FIG. 8B, each of the micropackets in the packet contains a header that designates the micropacket to follow. For example, header “4” designates micropacket uPack4, etc. This approach is less efficient than the serial access, since packet space Is occupied by the micropacket headers, however, this approach allows for the flexibility of aggregation of micropackets in random order. The receiving ambient device in this configuration receives the packet, and is programmed to identify the header of the appropriate micropacket, and to receive the data associated with the micropacket. All other micropackets are discarded. In some situations, it will be more efficient to update a smaller number of devices with larger micropackets, than all devices with smaller micropackets.

FIG. 8C illustrates the conventional approach of sub-addressing. In this approach, the packet includes a sub-packet identification, SUB_PACKID, which is followed by the data. Only one sub-packet is provided per packet, and the sub-packet cannot be removed from the transmission in order to optimize data space.

FIG. 9 is a front view of an example of the gauge embodiment of the ambient device 56C (see FIG. 1). The gauge includes a face 302 that is inserted into a gauge housing 308. The face 302 includes indicia that are representative of a particular form of data, in this example, the indicia represent portfolio performance in percentages. Three hands 304A, 304B, 304C are provided, the angular offset of each representing the ambient data to be displayed on the gauge. In this example, the longest hand 304A corresponds to the outermost indicia 3 10A and represents “current performance”, the middle hand 304B corresponds to the middle indicia 310B and represents “performance this month”, the shortest hand 304C corresponds to the innermost indicia 310C and represents “performance this year”. A motor 306 includes independent drives for each of the three hands 304A, 304B, 304C, such that the hands can be controlled independently by a controller, in response to the data transmitted to the gauge from the information server, as described above.

In a preferred embodiment, the face 302 is swappable, such that the indicia can be changed to represent any of a number of different types of data. With reference to FIG. 10, machine-readable markings, for example in the form of high-contrast light and dark circles 314 can be used to indicate a face serial number to automatically program the gauge for that particular face upon insertion of the face 302. If 2-way ambient device communication is employed, the serial number can be transmitted to the information server to alter the information that is transmitted to that device, or alternatively, the serial number can be used locally by the device to determine which packet and micropacket of received data should be selected for display.

In this manner, the swappable face permits the user to select the information for the gauge to display by inserting the appropriate printed card into a slot in the gauge housing. This approach therefore offers simple user interaction with information in near real time without the time, expense, and cognitive load of using a computer or other electronic device. The user can stay abreast of various forms of information without the interruption of a push device, or the skill and time required for a pull device.

In another embodiment, blank face cards may be provided for a user to write in customized information. For instance, the user may want to display the temperature of a city for which a pre-printed face card is not available, or may want the temperature limits to be different than what has been printed on the cards. In this example, once a user has illustrated the face (either by hand or via custom-designed graphic design software sent to a standard computer printer), the user can access the information server Web site for correlating the angular offset of the hands of the gauge with digitally available online information, as described above. Once the configuration is completed, the associated face can be interchanged with any other custom or preconfigured face to change the information display of the gauge. Optionally, other forms of media that interface with the gauge housing may be used for programming the gauge, such as magnetic media, electronic media, and the like. Such media may be included on the swappable gauge face 302, and read automatically by the housing 308, as described above

FIGS. 11A through 11F are front views of gauge embodiments, illustrating the utility of the swappable face card, in accordance with the present invention. In the example of FIG. 11A, the gauge includes a single hand 304A, the angular offset of which indicates stock market activity. In the example of FIG. 11B, the gauge includes two hands 304A, 30B, that indicate stock market volatility—“making highs” in a first quadrant, and “making lows” in a second quadrant. In this example, the hands 304A and 304B are of equal length. In the examples of FIGS. 11C-11F, the gauges include three hands The gauge of FIG. 11C displays the performance of three stock indices; the gauge of FIG. 11D displays an individual's portfolio performance over three different time periods; the gauge of FIG. 11E displays an individuals blood pressure over three different time periods; the gauge of FIG. 11F displays pollen count for three types of pollen.

FIG. 12 is a front view of an alternative embodiment of the gauge. In this example, the gauge displays the weather forecast, in terms of high temperature, for three distinct time periods: “today”, “tomorrow”, and “upcoming weekend”, using three different hands 304A, 304B, 304C that are independently controllable, as described above. In addition, light emitting diodes 310A, 310B, 310C are provided at the respective tips of the hands for conveying additional information in ambient form, for example the precipitation forecast for each respective time period. For example, if precipitation is forecasted for the time period, then the LED 310 can be placed in an “on” state for the respective hand. Alternatively, the LED 310 may comprise a multiple-state LED 310 that can be made to emit green light when no precipitation is forecasted, while the LED 310 can be made to glow red when precipitation is forecasted.

The motor 308 may comprise a servo motor such as the type of servo motor typically found in radio-controlled airplanes, in order to provide reliable angular offset of the hands. These servo motors are simple, 3-terminal devices controlled via a timing signal that can be readily generated by a low-cost microcontroller. Alternatively, DC motors supplemented by positional feedback, or inexpensive stepper motors may be employed. In one example, hollow coaxial shafts with staggered heights are coupled though pulleys, or alternatively meshed gears, to the servo motor, allowing each actuator to independently control a corresponding hand.

There are several conceivable ways of accomplishing local configuration for the gauge example. The approaches listed below are equally applicable to both 1-way and 2-way communication networks. 2-way schemes are more flexible in that they allow configuration of unique data that is not already broadcast onto the network. The 1-way schemes require the data to be broadcast on the network.

It is often the case that the gauge will be used to track information that varies with location, such as weather. A set of dials or other electromagnetic switching devices, on the back of the gauge can be used to select the zip code (in the United States) for the desired forecast location. This zip code can either be the zip code where the gauge is being used, or the zip code of another location where the user wishes to monitor the associated weather forecast.

If weather for all zip codes is being automatically broadcast by the wireless network, this local interface will simply select which packet and micropacket the gauge is listening to. If additional parameters are locally selectable, such as forecast period or format of weather conditions, the number of possible combinations may become too large to broadcast packets containing all possible data configurations. In this case, a 2-way network configuration is optimal because it allows a gauge to request data that would not otherwise be broadcast.

Unlike the electromechanical controls described above, an approach that employs swappable gauge faces allow for arbitrarily complex interfaces. Electromechanical controls are restricted to the configuration parameters designed in at the time of manufacture. For instance a weather gauge with adjustable zip code can never be configured to display pollen through a local interface selection (it can, however, be configured to display pollen count through some other means, such as by programming via a Web interface).

A key feature of swappable faces is the ease with which they can be created, either on a large scale with a printing press or copy machine, or on a small scale as with a home desktop printer. This feature provides consumers with the ability to create new faces containing new information configurations without the need to visit a Web site to configure the gauge.

An important issue associated with such swappable faces is the need to synchronize the graphical layout of the face with the angular offset of the multiple hands. For instance, if a different face is inserted, the hands must be moved to the correct positions to match the indicia on the newly inserted face. These positions will be different if a face for weather is inserted, or even if a face for the same information, but measured on a different scale, is inserted.

There are several means by which the faceplates can alter the information flow between the information server and remote ambient device. The serial number of the face encodes the local configuration information and is transmitted to the server. The server then responds with the appropriate micropacket for that information configuration.

For instance, the first five digits of the serial number may represent zip code, the next digit may represent channel (weather, traffic, pollen count), and the remaining digits are specific to each channel (e.g. for weather, the gauge is to display “high” or “low” temperature). The size of the serial number grows as the configuration is increasingly specified. Intricately configured information may require a larger serial number inefficient to transmit. Furthermore, every possible configuration must be standardized on the information server for proper decoding of the serial number encoding.

Alternatively, the serial numbers can have an arbitrary correlation with a particular information configuration. This allows a great deal of flexibility while keeping the size of serial numbers manageable. In theory, there only needs to be as many serial numbers as there are devices, as opposed to serial numbers for all possible configuration combinations.

Through centralized standardization at the ambient web server, a correlation can be established between certain serial numbers and certain information. For instance, serial number 0 is the weather forecast in Boston, serial number 1 is the weather forecast in San Francisco, serial number 2 is the performance of the DOW etc. In this approach, any standardized card can be inserted into any gauge and yield meaningful results. New channels are added by broadcasting a new micropacket, and then distributing faceplates corresponding to that new micropacket.

The addition of new channels can be restricted, or users can be allowed to use online tools (or similar) to create new correlations between unused serial numbers and micropacket configuration. Note that a portion of the serial number can be contained in the gauge housing, and not the faceplate. This allows serial numbers to be assigned on a “per-unit” basis, and not on a global basis. “Per-unit” serial number assignment restricts the use of any new faceplate to one particular gauge. Therefore, if user A creates a custom faceplate, and puts the faceplate in user B's gauge, the faceplate will not work properly, and may give incorrect results if user B has assigned that same custom serial number to a different data configuration. Per-unit serial number assignment restricts the availability of data to other users. It also shrinks the size of the serial number on the printed card. Cards only need to be unique to a particular user. Different users can use assign the same serial numbers to different data.

Global assignment of serial numbers, on the other hand, allows any user to publish data on the network, and by distributing faceplates (either hardcopy or electronic for user printouts), have access to an efficient means for other users to gain access to that same information. For instance, a ski resort operator could correlate a serial number with snow conditions for various ski runs. By publishing the graphical design of this faceplate, many users have the potential to access this information.

This feature creates the potential for a transaction network which charges a user a fee every time his information is broadcast, and pays the user a small fee every time his information is requested by another user. If the transmission network is 2-way, faceplate popularity can be determined electronically. 1-way transmission networks would require a different means to determine the usage of any particular faceplate.

The gauge embodiment is applicable to a number different form factors, including wall-mounted and desk-mounted form factors. In addition, while a gauge having hands of varying angular offset is described above, a linear gauge having hands of varying linear, or positional, offset is equally applicable to the present invention.

In another embodiment, the gauge may be configured to be worn on a human body, for example in a wristwatch-type application. In this embodiment, the gauge may be preprogrammed to receive a certain type of data (e.g. stock market performance). The data may be received in micropacket form, as described above, or alternatively, may comprise data that is broadcasted from a dedicated source in another format such as text.

The orb embodiment translates remote information into emitted light. In one example, stock market performance is displayed. If the market is doing well, the orb glows green. If the market is doing poorly, the orb glows red. If the market is flat, the orb is yellow. The color of the orb varies continuously between the green and red extremes as the market similarly moves.

If the market rises above the upper threshold, an animation such as pulsing can be initiated, with the speed of the pulsing proportional to the amount the market has risen above the threshold. Therefore, if the market is merely slightly above threshold, it will pulse slowly, whereas if the market is far beyond the threshold, it will pulse much faster.

The orb can also pulse different colors or perform more complex color animations to display different nuances of information. For instance, when set to track “weather”, the user can instruct the orb pulse rate to be proportional to the likelihood of upcoming rain. Furthermore the user can choose to have the orb perform a “heartbeat” pulse if the National Weather Forecast has issued a weather advisory statement. The orb can also alternate colors while pulsing. For instance, the orb can change between red and green color while pulsing.

In this manner, the orb displays information not just through the modulation of color, but also through recognizable animations of color. The color provides a primary means of acquiring information at a glance, and the animations enhance the meaning of that information channel.

FIGS. 13A and 13B are block diagrams of the components of a wireless gauge ambient object, in accordance with the present invention. A wireless data receiver 330 identifies wireless data packets according to their assigned packet identification (ID), and is programmed to receive packets having a specific packet ID. Following receipt of a packet, a micropacket extraction unit 332 extracts the expected micropacket 332 from the received packet. A decoder 334 converts the micropacket to signals that are applicable for the particular form of ambient object.

For example, with reference to the gauge example of FIG. 13A, the decoded signals are used to drive a motor controller 336 that drives three independent motors 338A, 338B, 338C to control the angular orientation 337A, 337B, 337C of the hands thereof.

With reference to the orb example of FIG. 13B, the decoded signals are used to program a light color controller 340 that drives an ambient light source 342. In this example, the color of the orb is controlled according to the decoded signals, along with light animations, such as pulsing, heartbeat, waltz, etc. In this example, the received micropacket includes two bytes of data, the bits of which provide for a primary orb color over a range of 36 color options, secondary orb color, over a range of 36 color options, and 6 types of animations, including none, slow, medium, fast, heartbeat, and crescendo. Other programming options are possible and equally applicable to the principles of the present invention.

A number of alternative embodiments of the ambient display can be conceived and are encompassed by the present invention. For example, in one embodiment, a spinning nautilus shell translates information into the speed of rotation of the nautilus shell. The spinning shell example is best suited for information which has both direction and magnitude, such as stock market performance, which can rise or fall by a small or large amount.

As an alternative to the orb example, a color changing device uses either a transmissive or reflective LCD (or similar) screen to modulate the perception of ambient white light. Such a device could last for many months or years on small batteries or even be solar powered.

In addition, the ambient device may employ a form of force modulation, mass modulation, friction, and the like, to convey information. In one example, force can be used to convey information. In our daily lives we are constantly opening, pushing, pulling, lifting, and setting down objects. The physical resistance these objects offer is a constant source of background information. For instance, a heavy milk carton indicates there is plenty of milk. This information is absorbed effortlessly, yet has the potential to change behavior. In this manner, the weight of an object can be altered to convey external information such as weather forecast.

In another example, mass modulation varies the mass of the object, which in turn changes the gravitational attraction to the earth. Changes in mass also change the inertia of the object, which is easily perceptible when accelerating and de-accelerating the object. Springs exert a force proportional to their displacement from resting position, according to Hooke's Law. By changing the resting location of the spring, the force exerted at any given displacement can be changed, in order to convey information. Friction is a force proportional to the velocity of an object. Friction can be varied with clutches and brakes to convey information. In addition, exotic materials, such as muscle wire, contract when heated by an electrical current. Connecting muscle wire to a spring allows the resting displacement of a spring to be changed and thus provide variable tension for conveying information.

Various combinations of the above force modulation devices can be deployed as ambient devices. In one example, an electronically controlled clutch varies the rotational resistance of a doorknob or latch. This resistance is proportional to some type of information configurable on the information server. In another example, a small tube integrated into the handset cord of a telephone pumps fluid in and out of a reservoir in the handset. This allows the handset to become lighter or heavier in response to some type of information. In another example, friction in the wheels which run in the guide tracks of a drawer is altered by an electronic clutch. Alternatively, the drawer is biased shut with a variable tension spring. Furthermore, the resistance a door offers when opened or closed can be modulated in many ways. Fluid can be pumped in and out of reservoirs or the hinges can be caused to have variable friction to convey information.

While this invention has been particularly shown and described with references to preferred embodiments thereof, it will be understood by those skilled in the art that various changes in form and details may be made herein without departing from the spirit and scope of the invention as defined by the appended claims.

We claim:

1. A system for the ambient presentation of information from a remote source comprising:
an information server receiving information from an information source; and
a translation unit for translating the information to an ambient data element, the ambient data element being optimized for presentation by a remote ambient object in ambient form.

2. The system of claim 1 wherein the translation unit translates the information to the ambient data element in response to translation rules.

3. The system of claim 2 wherein the translation rules are programmable by a user of the ambient object.

4. The system of claim 3 wherein the translation rules are programmable via a web-based interface.

5. The system of claim 3 wherein the translation rules are programmable via an electronic interface selected from the group of interfaces consisting of: telephonic, wireless, and pager devices.

6. The system of claim 3 wherein the translation rules are programmable at the ambient object.

7. The system of claim 3 wherein the translation rules are fixed at the information server.

8. The system of claim 1 wherein the translation unit comprises software that operates at the information server.

9. The system of claim 1 further comprising a transmission system for communicating the ambient data element to the remote ambient object.

10. The system of claim 9 further comprising an aggregation unit for aggregating multiple ambient data elements into an ambient data packet, and wherein the transmission system communicates the ambient data packet to multiple remote ambient objects.

11. The system of claim 10 wherein the transmission system comprises a wireless transmission system and wherein the ambient data packet is configured for transfer by the wireless transmission system.

12. The system of claim 10 wherein the ambient objects are programmed to receive an ambient data packet and to extract the respective ambient data element designated for the ambient device from the ambient data packet.

13. The system of claim 12 wherein the aggregation unit aggregates the multiple ambient data elements adjacent each other in the ambient data packet and wherein the ambient device extracts the ambient data element from the ambient data packet according to a programmed numeric offset that corresponds to the position of the ambient data element in the ambient data packet.

14. The system of claim 13 wherein the numeric offset is fixed or variable.

15. The system of claim 12 wherein the aggregation unit aggregates the multiple ambient data elements into the ambient data packet with an associated element identification header, and wherein the ambient device extracts the ambient data element from the ambient data packet in response to the element identification header.

16. The system of claim 12 wherein the aggregation unit aggregates the multiple ambient data elements into the ambient data packet and wherein the ambient object extracts the ambient data element from the ambient data packet in response to a programmable selection signal.

17. The system of claim 16 wherein the programmable selection signal is generated at the ambient object.

18 The system of claim 17 wherein the programmable selection signal is generated in response to a medium that locally interfaces with the ambient object.

19. The system of claim 18 wherein the medium comprises a user swappable gauge face selected from the group of media consisting of: a printed medium, an electronic medium, and a magnetic medium.

20 The system of claim 17 wherein the programmable selection signal is generated in response to a dial or switches located at the ambient object.

21. The system of claim 9 wherein the transmission system comprises a one-way wireless communication system.

22. The system of claim 9 wherein the transmission system comprises a two-way wireless communication system.

23. The system of claim 9 wherein the transmission system comprises a distributed data network.

24. The system of claim 23 wherein the distributed data network is a network selected from the group consisting of: pager, telephone, wireless data, and Internet.

25. The system of claim 1 wherein the ambient data is optimized for instructing the ambient object for presentation of the information in ambient form, so as to minimize the amount of data that is transferred from the information server to the ambient object.

26. The system of claim 1 wherein the ambient object comprises an object selected from the group consisting of: a light of varying color, a gauge with hands of varying angular or linear offset; and a device that varies in mass or force required to operate.

27. The system of claim 1 wherein the ambient object comprises an object that is wearable on a human body.

28. The system of claim 27 wherein the ambient object comprises a wristwatch-type device having a gauge with at least one hand that varies in angular or linear offset in response to the ambient data.

29. The system of claim 1 wherein the information comprises textural or quantitative electronic data related to an event that is remote from the ambient object.

30. An ambient object for the ambient presentation of remote information comprising:
a receiver for receiving an ambient data element from a remote information source, the ambient data element being optimized for presentation at the ambient object, and being representative of remote information; and
a presentation unit for presenting the received ambient data element in ambient form.

31. The ambient object of claim 30 wherein the remote information source comprises an information server.

32. The ambient object of claim 30 wherein the receiver comprises a wireless data packet receiver.

33. The ambient object of claim 30 wherein the ambient data element is received in aggregated form with multiple ambient data elements in an ambient data packet, and wherein the receiver extracts the respective data element designated for the ambient device from the ambient data packet.

34. The ambient object of claim 33 wherein the receiver extracts the ambient data element from the ambient data packet according to a programmed numeric offset that corresponds to the position of the ambient data element in the ambient data packet.

35. The ambient object of claim 34 wherein the numeric offset is fixed or variable.

36. The ambient object of claim 33 wherein the receiver extracts the ambient data element from the ambient data packet in response to an element identification header.

37. The ambient object of claim 33 wherein the receiver extracts the ambient data element from the ambient data packet in response to a programmable selection signal.

38. The ambient object of claim 37 wherein the programmable selection signal is generated at the ambient object.

39 The ambient object of claim 37 wherein the programmable selection signal is generated in response to a medium that interfaces with the ambient object.

40. The ambient object of claim 39 wherein the medium comprises a user swappable gauge face selected from the group of media consisting of: a printed medium, an electronic medium, and a magnetic medium.

41 The ambient object of claim 37 wherein the programmable selection signal is generated in response to a dial or switches located at the ambient object.

42. The ambient object of claim 30 wherein the presentation unit comprises a light source, the emitted wavelength of which is varied in response to the received ambient data element.

43. The ambient object of claim 30 wherein the presentation unit comprises a gauge having a hand and a controller for varying the angular or linear offset of the hand with respect to the gauge in response to the received ambient data element.

44. The ambient object of claim 43 wherein the gauge is wearable on a human body.

45. The ambient object of claim 44 wherein the gauge comprises a wristwatch-type device.

46. The ambient object of claim 43 wherein the hand comprises multiple hands and wherein the controller varies the angular or linear offset of each of the multiple hands independently, in response to multiple aspects of the remote information.

47. The ambient object of claim 30 wherein the remote information comprises textural or quantitative electronic data related to an event that is remote from the ambient object.

48. The ambient object of claim 30 wherein the ambient data element is translated from the remote information at an information server that is remote from the ambient object, in response to translation rules.

49. The ambient object of claim 48 wherein the translation rules are programmable by a user of the ambient object via a web-based interface.

50. The ambient object of claim 48 wherein the translation rules are programmable at the ambient object.

51. The ambient object of claim 48 wherein the translation rules are fixed at the information server.

52. An ambient object for the ambient presentation of remote information comprising:
a gauge with a hand;
a receiver for receiving information from a remote information source; and
a controller for varying the angular or linear offset of the hand with respect to the gauge in response to the received information.

53. The ambient object of claim 52 wherein the gauge is wearable on a human body.

54. The ambient object of claim 53 wherein the gauge comprises a wristwatch-type device.

55. The ambient object of claim 52 wherein the information received from the remote information source comprises ambient data that is optimized for instructing the controller for varying the angular or linear offset of the hand with respect to the gauge.

56. The ambient object of claim 52 wherein the information received from the remote information source comprises textural or quantitative data.

57. The ambient object of claim 52 wherein the hand comprises multiple hands and wherein the controller varies the angular or linear offset of each of the multiple hands independently, in response to like multiple different aspects of the remote information.

58. A method for the ambient presentation of information from a remote source comprising:
receiving information from an information source at an information server; and
translating the information to an ambient data element, the ambient data element being optimized for presentation by a remote ambient object in ambient form.

59. The method of claim 58 further comprising translating the information to the ambient data element in response to translation rules.

60. The method of claim 59 wherein the translation rules are programmable by a user of the ambient object.

61. The method of claim 60 further comprising programming the translation rules via a web-based interface.

62. The method of claim 60 further comprising programming the translation rules via an electronic interface selected from the group of interfaces consisting of: telephonic, wireless, and pager devices.

63. The method of claim 60 further comprising programming the translation rules at the ambient object.

64. The method of claim 60 further comprising programming the translation rules at the information server.

65. The method of claim 58 further comprising communicating the ambient data element to the remote ambient object.

66. The method of claim 65 further comprising aggregating multiple ambient data elements into an ambient data packet, and communicating the ambient data packet to multiple remote ambient objects.

67. The method of claim 66 wherein communicating comprises communicating on a wireless transmission system and wherein the ambient data packet is configured for transfer by the wireless transmission system.

68. The method of claim 66 wherein the ambient objects are programmed to receive an ambient data packet and to extract the respective ambient data element designated for the ambient object from the ambient data packet.

69. The method of claim 68 further comprising aggregating the multiple ambient data elements adjacent each other in the ambient data packet and wherein the ambient object extracts the ambient data element from the ambient data packet according to a programmed numeric offset that corresponds to the position of the ambient data element in the ambient data packet.

70. The method of claim 69 wherein the numeric offset is fixed or variable.

71. The method of claim 68 further comprising aggregating the multiple ambient data elements into the ambient data packet with an associated element identification header, and wherein the ambient object extracts the ambient data element from the ambient data packet in response to the element identification header.

72. The method of claim 68 wherein the aggregation unit aggregates the multiple ambient data elements into the ambient data packet and wherein the ambient object extracts the ambient data element from the ambient data packet in response to a programmable selection signal.

73. The method of claim 72 wherein the programmable selection signal is generated at the ambient object.

74. The method of claim 72 wherein the programmable selection signal is generated in response to a medium that locally interfaces with the ambient object.

75. The method of claim 72 wherein the programmable selection signal is generated in response to a dial or switches located at the ambient object.

76. The method of claim 58 wherein the ambient data is optimized for instructing the ambient object for presentation of the information in ambient form, so as to minimize the amount of data that is transferred from the information server to the ambient object.

77. The method of claim 58 wherein the ambient object comprises an object selected from the group consisting of: a light of varying color, a gauge with hands of varying angular or linear offset; and a device that varies in mass or force required to operate.

78. The method of claim 58 wherein the ambient object comprises an object that is wearable on a human body.

79. The system of claim 78 wherein the ambient object comprises a wristwatch-type device having a gauge with at least one hand that varies in angular or linear offset in response to the ambient data.

80. The method of claim 58 wherein the information comprises textural or quantitative electronic data related to an event that is remote from the ambient object.

81. A method for the ambient presentation of remote information at an ambient object comprising:
receiving an ambient data element from a remote information source, the ambient data element being optimized for presentation at the ambient object, and being representative of remote information; and
presenting the received ambient data element in ambient form.

82. The method of claim 81 wherein the remote information source comprises an information server.

83. The method of claim 81 further comprising receiving the ambient data element at a wireless data packet receiver.

84. The method of claim 81 wherein the ambient data element is received in aggregated form with multiple ambient data elements in an ambient data packet, and further comprising extracting the respective data element designated for the ambient device from the ambient data packet.

85. The method of claim 84 further comprising extracting the ambient data element from the ambient data packet according to a programmed numeric offset that corresponds to the position of the ambient data element in the ambient data packet.

86. The method of claim 85 wherein the numeric offset is fixed or variable.

87. The method of claim 84 further comprising extracting the ambient data element from the ambient data packet in response to an element identification header.

88. The method of claim 84 further comprising extracting the ambient data element from the ambient data packet in response to a programmable selection signal.

89. The method of claim 88 wherein the programmable selection signal is generated at the ambient object.

90 The method of claim 88 wherein the programmable selection signal is generated in response to a medium that interfaces with the ambient object.

91. The method of claim 90 wherein the medium comprises a user swappable gauge face selected from the group of media consisting of: a printed medium, an electronic medium, and a magnetic medium.

92 The method of claim 88 wherein the programmable selection signal is generated in response to a dial or switches located at the ambient object.

93. The method of claim 81 further comprising presenting the received ambient data element at a presentation unit comprising a light source, the emitted wavelength of which is varied in response to the received ambient data element.

94. The method of claim 81 further comprising presenting the received ambient data element at a presentation unit comprising gauge having a hand and a controller for varying the angular or linear offset of the hand with respect to the gauge in response to the received ambient data element.

95. The method of claim 94 wherein the gauge is wearable on a human body.

96. The method of claim 95 wherein the gauge comprises a wristwatch-type device.

97. The method of claim 94 wherein the hand comprises multiple hands and wherein the controller varies the angular or linear offset of each of the multiple hands independently, in response to multiple aspects of the remote information.

98. The method of claim 81 wherein the remote information comprises textural or quantitative electronic data related to an event that is remote from the ambient object.

99. The method of claim 81 wherein the ambient data element is translated from the remote information at an information server that is remote from the ambient object, in response to translation rules.

100. The method of claim 99 wherein the translation rules are programmable by a user of the ambient object via a web-based interface.

101. The method of claim 99 wherein the translation rules are programmable at the ambient object.

102. The method of claim 99 wherein the translation rules are fixed at the information server.
